(19) United States
(12) Patent Application Publication
(10) Pub. No.: US 2026/0349554 A1
(43) Pub. Date: Nov. 5, 2026

(54) DISPLAY DEVICE, METHOD OF OPERATING THE DISPLAY DEVICE, AND ELECTRONIC DEVICE INCLUDING THE DISPLAY DEVICE

(71) Applicant: Samsung Display Co., Ltd., Yongin-Si (KR)

(72) Inventors: IL HO LEE, Yongin-si (KR); JEONMIN KANG, Yongin-si (KR); YUJIN SHIN, Yongin-si (KR); GAYEON YUN, Yongin-si (KR); SEUNGROK LEE, Yongin-si (KR)

(21) Appl. No.: 19/403,001

(22) Filed: Nov. 27, 2025

(30) Foreign Application Priority Data
May 2, 2025 (KR) 10-2025-0057979

(51) Int. Cl. G06F 3/041

(52) U.S. Cl. CPC G06F 3/0416; G06F 3/0412

(57) ABSTRACT

A display device may include a display panel, display panel driver, a touch panel including first to m-th touch electrodes, and a touch panel driver which drives the touch panel. The touch panel driver may calculate first to m-th offset values which serve as a reference for determining whether the first to m-th touch electrodes are touched, may calculate a k-th factor of a k-th touch electrode based on a k-th offset value of the k-th touch electrode and an offset value of each of first to n-th adjacent touch electrodes which are adjacent to the k-th touch electrode, may calculate a k-th touch factor of the k-th touch electrode based on the k-th factor of the k-th touch electrode and a k-th reference factor of the k-th touch electrode, and may determine whether to update the first to m-th offset values based on first to m-th touch factors.

### CROSS-REFERENCE TO RELATED APPLICATION(S)

This application claims priority under 35 U.S.C. § 119 to Korean Patent Application No. 10-2025-0057979, filed on May 2, 2025 in the Korean Intellectual Property Office KIPO, the contents of which are herein incorporated by reference in their entireties.

### BACKGROUND

### Field

Embodiments of the present inventive concept relate to a display device, a method of operating the display device, and an electronic device including the display device.

### Description of the Related Art

A display device may include a display panel and a display panel driver. The display panel may include gate lines, emission lines, data lines, and pixels. The display panel driver may include a gate driver which provides gate signals to the gate lines, an emission driver which provides emission signals to the emission lines, a data driver which outputs data voltages to the data lines, and a driving controller which controls the gate driver, the emission driver, and the data driver.

The display device may further include a touch sensing device. The touch sensing device may include a touch panel and a touch panel driver which drives the touch panel. A conventional touch sensing device may not accurately distinguish various touch types. The conventional touch sensing device does not accurately distinguish various touch types, so that the conventional touch sensing device may not accurately determine whether the touch panel is touched. Accordingly, reliability of the conventional touch sensing device may decrease, and reliability of the display device including the conventional touch sensing device may decrease.

### SUMMARY

A feature of the present disclosure is to provide a display device of which reliability is improved.

Another feature of the present disclosure is to provide a method of operating the display device.

Still another feature of the present disclosure is to provide an electronic device including the display device.

However, features of the present disclosure are not limited to the above features, and may be variously extended without departing from the spirit and scope of the present disclosure.

According to embodiments, a display device may include a display panel including pixels, a display panel driver configured to drive the display panel, a touch panel including first to m-th touch electrodes, where m is an integer equal to or greater than 10, and a touch panel driver configured to drive the touch panel. The touch panel driver may be configured to calculate first to m-th offset values which serve as a criterion for determining whether the first to m-th touch electrodes are touched and which correspond to each of the first to m-th touch electrodes, to calculate a k-th factor, where k is an integer equal to or greater than 1 and less than or equal to m, of a k-th touch electrode for the first to m-th touch electrodes based on a k-th offset value of the k-th touch electrode and an offset value of each of first to n-th adjacent touch electrodes which are adjacent to the k-th touch electrode, where n is an integer equal to or greater than 2 and less than or equal to 4, to calculate a k-th touch factor of the k-th touch electrode based on the k-th factor of the k-th touch electrode and a k-th reference factor which is the k-th factor of the k-th touch electrode when the k-th touch electrode is not touched, and to determine whether to update the first to m-th offset values based on first to m-th touch factors for each of the first to m-th touch electrodes.

In an embodiment, the touch panel driver may be configured to calculate first to n-th sub-factors of the k-th touch electrode based on the k-th offset value of the k-th touch electrode and the offset value of each of the first to n-th adjacent touch electrodes and to determine a sub-factor having a maximum value among the first to n-th sub-factors as the k-th factor of the k-th touch electrode.

In an embodiment, the touch panel driver may be configured to determine a touch factor having a maximum value among the first to m-th touch factors as a maximum touch factor.

In an embodiment, the touch panel driver may be configured to determine whether to update the first to m-th offset values for each of the first to m-th touch electrodes based on the maximum touch factor and threshold values.

In an embodiment, the touch panel driver may be configured to update the first to m-th offset values when the maximum touch factor is less than a first threshold value.

In an embodiment, the touch panel driver may be configured not to update the first to m-th offset values when the maximum touch factor is greater than a second threshold value, the second threshold being greater than the first threshold value, and is less than a third threshold value, the third threshold value being greater than the second threshold value.

In an embodiment, the touch panel driver may be configured not to update the first to m-th offset values when the maximum touch factor is greater than a fourth threshold value, the fourth threshold being greater than the third threshold value.

According to embodiments, a method of operating the display device may include calculating first to m-th offset values which serves as a criterion for determining whether first to m-th touch electrodes are touched and which correspond to each of the first to m-th touch electrodes, where m is an integer equal to and greater than 10, calculating a k-th factor of a k-th touch electrode for the first to m-th touch electrodes based on a k-th offset value of the k-th touch electrode, where k is an integer equal to or greater than 1 and less than or equal to m, and an offset value of each of first to n-th adjacent touch electrodes which are adjacent to the k-th touch electrode, where n is an integer equal to or greater than 2 and less than or equal to 4, calculating a k-th touch factor of the k-th touch electrode based on the k-th factor of the k-th touch electrode and a k-th reference factor which is the k-th factor of the k-th touch electrode when the k-th touch electrode is not touched, and determining whether to update the first to m-th offset values based on first to m-th touch factors for each of the first to m-th touch electrodes.

In an embodiment, the calculating the k-th factor of the k-th touch electrode for the first to m-th touch electrodes based on the k-th offset value of the k-th touch electrode and the offset value of each of the first to n-th adjacent touch electrodes which are adjacent to the k-th touch electrode may include calculating first to n-th sub-factors of the k-th touch electrode based on the k-th offset value of the k-th touch electrode and the offset value of each of the first to n-th adjacent touch electrodes and determining a sub-factor having a maximum value among the first to n-th sub-factors as the k-th factor of the k-th touch electrode.

In an embodiment, the determining whether to update the first to m-th offset values based on the first to m-th touch factors for each of the first to m-th touch electrodes may include determining a touch factor having a maximum value among the first to m-th touch factors as a maximum touch factor.

In an embodiment, the determining whether to update the first to m-th offset values based on the first to m-th touch factors for each of the first to m-th touch electrodes may further include determining whether to update the first to m-th offset values for each of the first to m-th touch electrodes based on the maximum touch factor and threshold values.

In an embodiment, in the determining whether to update the first to m-th offset values for each of the first to m-th touch electrodes based on the maximum touch factor and the threshold values, the first to m-th offset values may be updated when the maximum touch factor is less than a first threshold value.

In an embodiment, in the determining whether to update the first to m-th offset values for each of the first to m-th touch electrodes based on the maximum touch factor and the threshold values, the first to m-th offset values may be not updated when the maximum touch factor is greater than a second threshold value, the second threshold being greater than the first threshold value, and less than a third threshold value, the third threshold value being greater than the second threshold value.

In an embodiment, in the determining whether to update the first to m-th offset values for each of the first to m-th touch electrodes based on the maximum touch factor and the threshold values, the first to m-th offset values may be not updated when the maximum touch factor is greater than a fourth threshold value, the fourth threshold being greater than the third threshold value.

According to embodiments, an electronic device may include one or more processors configured to generate an input control signal and input image data, a display panel including pixels, a display panel driver configured to drive the display panel based on the input control signal and the input image data, a touch panel including first to m-th touch electrodes, where m is an integer equal to and greater than 10, and a touch panel driver configured to drive the touch panel. The touch panel driver may be configured to calculate first to m-th offset values which serve as a criterion for determining whether the first to m-th touch electrodes are touched and which correspond to each of the first to m-th touch electrodes, to calculate a k-th factor of a k-th touch electrode for the first to m-th touch electrodes based on a k-th offset value of the k-th touch electrode, where k is an integer equal to or greater than 1 and less than or equal to m, and an offset value of each of first to n-th adjacent touch electrodes which are adjacent to the k-th touch electrode, where n is an integer equal to or greater than 2 and less than or equal to 4, to calculate a k-th touch factor of the k-th touch electrode based on the k-th factor of the k-th touch electrode and a k-th reference factor which is the k-th factor of the k-th touch electrode when the k-th touch electrode is not touched, and to determine whether to update the first to m-th offset values based on first to m-th touch factors for each of the first to m-th touch electrodes.

In an embodiment, the touch panel driver may be configured to calculate first to n-th sub-factors of the k-th touch electrode based on the k-th offset value of the k-th touch electrode and the offset value of each of the first to n-th adjacent touch electrodes and to determine a sub-factor having a maximum value among the first to n-th sub-factors as the k-th factor of the k-th touch electrode.

In an embodiment, the touch panel driver may be configured to determine a touch factor having a maximum value among the first to m-th touch factors as a maximum touch factor and to determine whether to update the first to m-th offset values for each of the first to m-th touch electrodes based on the maximum touch factor and threshold values.

In an embodiment, the touch panel driver may be configured to update the first to m-th offset values when the maximum touch factor is less than a first threshold value.

In an embodiment, the touch panel driver may be configured not to update the first to m-th offset values when the maximum touch factor is greater than a second threshold value, which is greater than the first threshold value, the second threshold being less than a third threshold value, the third threshold value being greater than the second threshold value.

In an embodiment, the touch panel driver may be configured not to update the first to m-th offset values when the maximum touch factor is greater than a fourth threshold value, the fourth threshold being greater than the third threshold value.

Therefore, the display device may include the display panel including the pixels, the display panel driver which drives the display panel, the touch panel including the first to m-th touch electrodes, and the touch panel driver which drives the touch panel.

The touch panel driver may calculate the first to m-th offset values which serve as the criterion for determining whether the first to m-th touch electrodes are touched and which correspond to each of the first to m-th touch electrodes, may calculate the k-th factor of the k-th touch electrode for the first to m-th touch electrodes based on the k-th offset value of the k-th touch electrode and the offset value of each of the first to n-th adjacent touch electrodes which are adjacent to the k-th touch electrode, may calculate the k-th touch factor of the k-th touch electrode based on the k-th factor of the k-th touch electrode and the k-th reference factor which is the k-th factor of the k-th touch electrode when the k-th touch electrode is not touched, and may determine whether to update the first to m-th offset values based on the first to m-th touch factors for each of the first to m-th touch electrodes.

The touch panel driving circuit calculates first to m-th factors for the first to m-th touch electrodes based on first to m-th offset values, calculates the first to m-th touch factors based on the first to m-th factors and the first to m-th reference factors, determine the maximum touch factor based on the first to m-th touch factors, and compares the maximum touch factor with first to fourth threshold values, so that the touch panel driver 320 may accurately distinguish a first case in which the touch panel is not touched, a second case in which the touch panel is not touched and a conductor approaches the touch panel, and a third case in which the touch panel is touched. The first to third cases are accurately distinguished, so that the first to m-th offset values may be normally updated. The first to m-th offset values are normally updated, so that the touch sensing device may accurately recognize a touch of a user of the display device. That is, reliability of the touch sensing device may be improved and reliability of the display device including the touch sensing device may be improved.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display device according to embodiments of the present inventive concept.

FIG. 2 is a block diagram illustrating a display panel and a display panel driver included in the display device of FIG. 1.

FIG. 3 is a block diagram illustrating an embodiment of an operation of a touch sensing device included in the display device of FIG. 1.

FIG. 4 is a block diagram illustrating the touch sensing device included in the display device of FIG. 1.

FIG. 5 is a graph illustrating an offset value, a current value, and a touch value for explaining a criterion for touch recognition.

FIG. 6A is a diagram illustrating a first case in which a touch panel included in the touch sensing device of FIG. 4 is not touched.

FIG. 6B is a diagram illustrating a second case in which a conductor approaches the touch panel included in the touch sensing device of FIG. 4.

FIG. 6C is a diagram illustrating a third case in which the touch panel included in the touch sensing device of FIG. 4 is touched.

FIG. 7 is a flowchart illustrating a first operation of a touch panel driver included in the touch sensing device of FIG. 4.

FIG. 8 is a flowchart illustrating a second operation of the touch panel driver included in the touch sensing device of FIG. 4.

FIG. 9 is a diagram illustrating that the touch panel driver included in the touch sensing device of FIG. 4 distinguishes the first to third cases based on threshold values.

FIG. 10A is a table illustrating reference offset values corresponding to each of first to m-th touch electrodes of the touch panel included in the touch sensing device of FIG. 4.

FIG. 10B is a table illustrating reference factors for each of the first to m-th touch electrodes of the touch panel included in the touch sensing device of FIG. 4.

FIG. 11A is a table illustrating first to m-th offset values corresponding to each of the first to m-th touch electrodes of the touch panel included in the touch sensing device of FIG. 4 in the first case.

FIG. 11B is a table illustrating first to m-th factors for each of the first to m-th touch electrodes of the touch panel included in the touch sensing device of FIG. 4 in the first case.

FIG. 11C is a table illustrating first to m-th touch factors for each of the first to m-th touch electrodes of the touch panel included in the touch sensing device of FIG. 4 in the first case.

FIG. 12A is a table illustrating first to m-th offset values corresponding to each of the first to m-th touch electrodes of the touch panel included in the touch sensing device of FIG. 4 in the second case.

FIG. 12B is a table illustrating first to m-th factors for each of the first to m-th touch electrodes of the touch panel included in the touch sensing device of FIG. 4 in the second case.

FIG. 12C is a table illustrating first to m-th touch factors for each of the first to m-th touch electrodes of the touch panel included in the touch sensing device of FIG. 4 in the second case.

FIG. 13A is a table illustrating first to m-th offset values corresponding to each of the first to m-th touch electrodes of the touch panel included in the touch sensing device of FIG. 4 in the third case.

FIG. 13B is a table illustrating first to m-th factors for each of the first to m-th touch electrodes of the touch panel included in the touch sensing device of FIG. 4 in the third case.

FIG. 13C is a table illustrating first to m-th touch factors for each of the first to m-th touch electrodes of the touch panel included in the touch sensing device of FIG. 4 in the third case.

FIG. 14 is a flowchart illustrating a method of operating the display device of FIG. 1.

FIG. 15 is a block diagram illustrating an electronic device according to embodiments of the present inventive concept.

FIG. 16 is a diagram illustrating schematics of the electronic device of FIG. 15.

### DETAILED DESCRIPTION OF THE EMBODIMENTS

Hereinafter, display devices in accordance with embodiments will be described in more detail with reference to the accompanying drawings. The same reference numerals are used for the same components in the drawings, and redundant descriptions of the same components will be omitted.

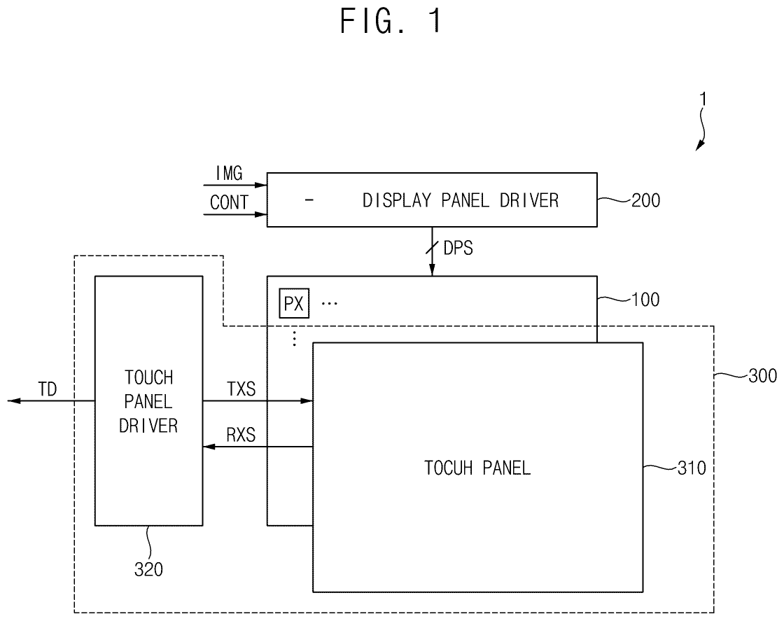

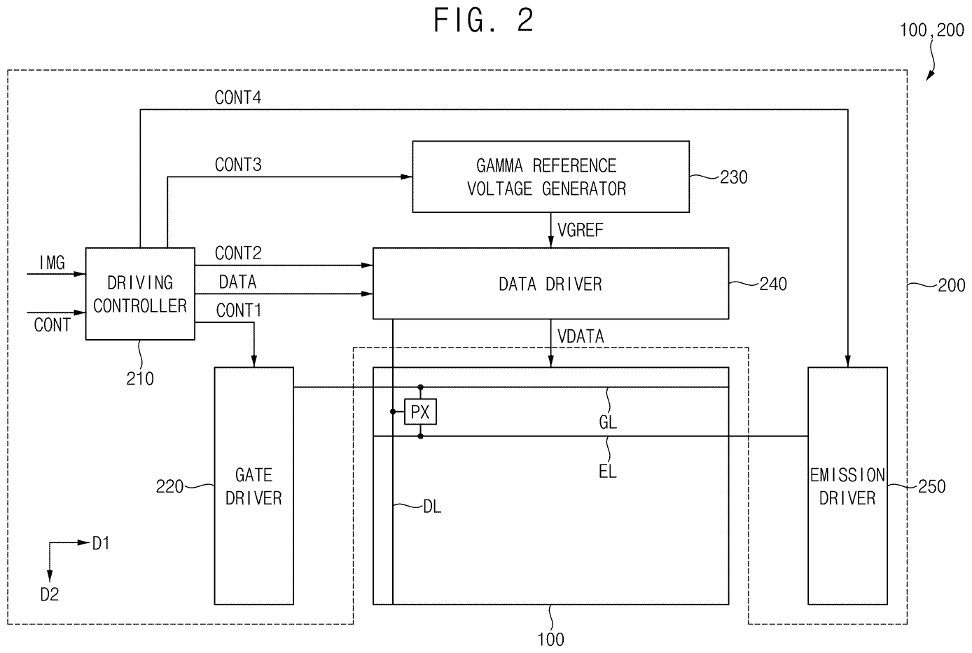

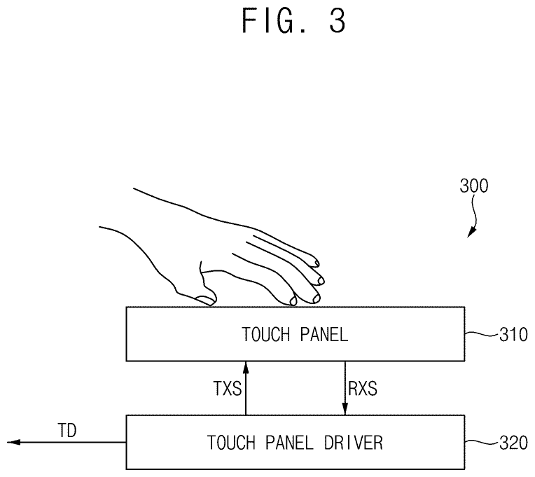

FIG. 1 is a block diagram illustrating a display device 1 according to embodiments of the present inventive concept. FIG. 2 is a block diagram illustrating a display panel 100 and a display panel driver 200 included in the display device 1 of FIG. 1. FIG. 3 is a block diagram illustrating an embodiment of an operation of a touch sensing device 300 included in the display device 1 of FIG. 1.

Referring to FIGS. 1 to 3, the display device 1 may include the display panel 100 and the display panel driver 200. The display device 1 may further include the touch sensing device 300.

The display panel 100 may have a display region on which an image is displayed and a peripheral region adjacent to the display region. For example, the peripheral region may be referred to as a bezel.

The display panel 100 may include gate lines GL, emission lines EL, data lines DL, and pixels PX. For example, the gate lines GL may extend in a first direction D1 and the emission lines EL may extend in the first direction D1. The data lines DL may extend in a second direction D2 crossing the first direction D1 and

The display panel driver 200 may include a driving controller 210, a gate driver 220, a gamma reference voltage generator 230, a data driver 240, and an emission driver 250.

The display panel 200 may generate a display panel driving signal DPS based on input image data IMG and an input control signal CONT and may provide the display panel driving signal DPS to the display panel 100. The display panel driving signal DPS may include gate signals, data voltages VDATA, and emission signals, but the display panel driving signal DPS is not limited thereto.

For example, the driving controller 210 and the data driver 240 may be integrally formed. For example, the driving controller 210, the gamma reference voltage generator 230, and the data driver 240 may be integrally formed. A driving module including at least the driving controller 210 and the data driver 240 which are integrally formed may be referred to as a timing controller embedded data driver (TED).

The driving controller 210 may receive the input image data IMG and the input control signal CONT from an external device. For example, the input image data IMG may include red image data, green image data, and blue image data. In some embodiments, the input image data IMG may further include white image data. In another example, the input image data IMG may include magenta image data, cyan image data, and yellow image data. The input control signal CONT may include a master clock signal and a data enable signal. The input control signal CONT may further include a vertical synchronizing signal and a horizontal synchronizing signal.

The driving controller 210 may generate a gate control signal CONT1, a data control signal CONT2, a gamma control signal CONT3, an emission control signal CONT4, and a data signal DATA based on the input image data IMG and the input control signal CONT.

The driving controller 210 may generate the gate control signal CONT1 for controlling an operation of the gate driver 220 based on the input control signal CONT, and may output the gate control signal CONT1 to the gate driver 220. The gate control signal CONT1 may include a vertical gate start signal and a gate clock signal.

The driving controller 210 may generate the data control signal CONT2 for controlling an operation of the data driver 240 based on the input control signal CONT, and may output the data control signal CONT2 to the data driver 240. The data control signal CONT2 may include a horizontal start signal and a load signal.

The driving controller 210 may generate the data signal DATA based on the input image data IMG. The driving controller 210 may output the data signal DATA to the data driver 240.

The driving controller 210 may generate the gamma control signal CONT3 for controlling an operation of the gamma reference voltage generator 230 based on the input control signal CONT, and may output the gamma control signal CONT3 to the gamma reference voltage generator 230.

The driving controller 210 may generate the emission control signal CONT4 for controlling an operation of the emission driver 250 based on the input control signal CONT, and may output the emission control signal CONT4 to the emission driver 250. The emission control signal CONT4 may include a vertical emission start signal and an emission clock signal.

The gate driver 220 may generate the gate signals transmitted to the pixel PX through the gate lines GL in response to the gate control signal CONT1 received from the driving controller 210. The gate driver 220 may output the gate signals to the gate lines GL.

In an embodiment, the gate driver 220 may be integrated on the peripheral region of the display panel 100. In an embodiment, the gate driver 220 may be mounted on the peripheral region of the display panel 100.

The gamma reference voltage generator 230 may generate a gamma reference voltage VGREF in response to the gamma control signal CONT3 received from the driving controller 210. The gamma reference voltage generator 230 may output the gamma reference voltage VGREF to the data driver 240.

In an embodiment, the gamma reference voltage generator 230 may be disposed in the driving controller 210, or in the data driver 240.

The data driver 240 may receive the data control signal CONT2 and the data signal DATA from the driving controller 210, and may receive the gamma reference voltages VGREF from the gamma reference voltage generator 230. The data driver 240 may convert the data signal DATA having a digital type into data voltages VDATA having an analog type using the gamma reference voltages VGREF. The data driver 240 may output the data voltages VDATA to the data lines DL.

In an embodiment, the data driver 240 may be integrated on the peripheral region of the display panel 100. In an embodiment, the data driver 240 may be mounted on the peripheral region of the display panel 100.

The emission driver 250 may generate the emission signals transmitted to the pixel PX through the emission lines EL in response to the emission control signal CONT4 received from the driving controller 210. The emission driver 250 may output the emission signals to the emission lines EL.

In an embodiment, the emission driver 250 may be integrated on the peripheral region of the display panel 100. In an embodiment, the emission driver 250 may be mounted on the peripheral region of the display panel 100.

The touch sensing device 300 may include a touch panel 310 and a touch panel driver 320.

The touch panel 310 may include touch electrodes. The touch panel driver 320 may detect a touch of a user of the display device 1 through the touch electrodes included in the touch panel 310.

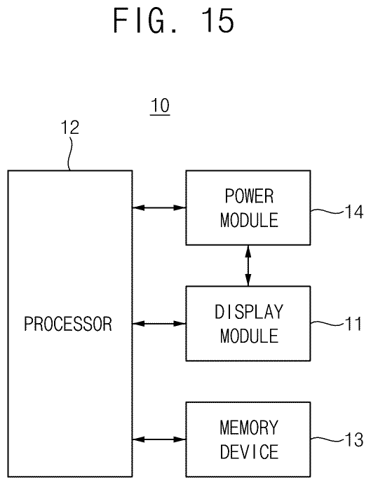

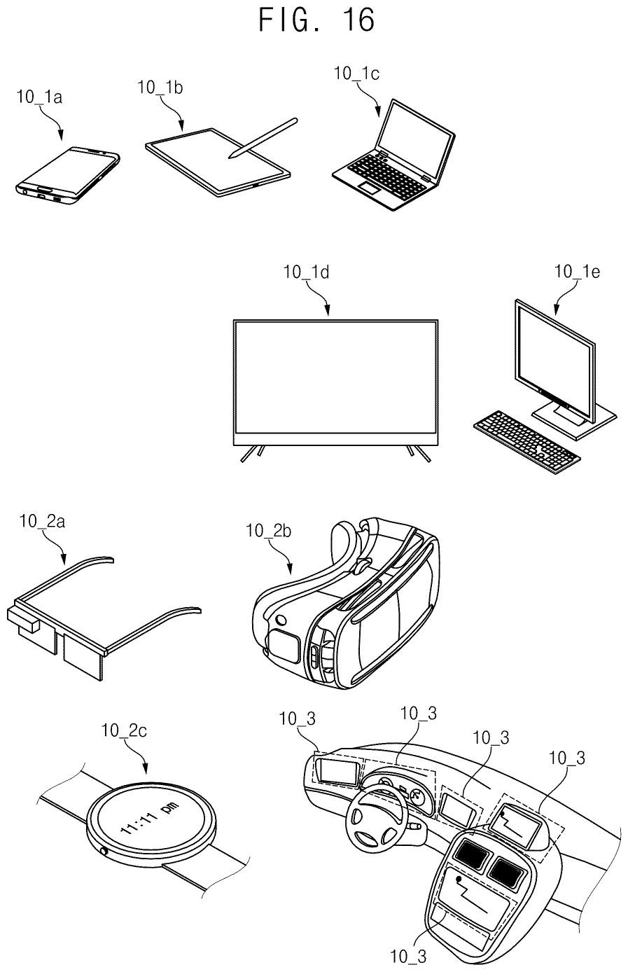

The touch panel driver 320 may generate touch driving signals TXS, may provide the touch driving signals TXS to the touch panel 310, and may receive touch sensing signals RXS from the touch panel 310. The touch panel driver 320 may detect the touch of the user of the display device 1 on the touch panel 310 based on the touch sensing signals RXS. The touch panel driver 320 may generate touch data TD for the touch of the user of the display device 1 on the touch panel 310 and may provide the touch data TD to the display panel driver 200 or to an external device (e.g. a processor 12 of FIG. 15).

In an embodiment, the touch panel 310 may be touched by a palm of the user of the display device 1. The touch panel driver 320 may generate the touch driving signals TXS, may provide the touch driving signals TXS to the touch panel 310, and may receive the touch sensing signals RXS from the touch panel 310. The touch panel driver 320 may detect a palm touch of the user of the display device 1 on the touch panel 310 based on the touch sensing signals RXS. The touch panel driver 320 may generate the touch data TD for the palm touch of the user of the display device 1 on the touch panel 310.

In an embodiment, the touch panel 310 may operate by a capacitance method which detects a change in capacitance caused by the touch of the user of the display device 1, but the touch panel 310 is not limited thereto. The touch panel 310 may be mounted on one surface of the display panel 100 or may be formed in the display panel 100. For example, the touch panel 310 may be formed by an on cell touch AMOLED (OCTA) method in which the touch panel 310 is embedded in the display panel 100. For convenience of explanation, it is assumed that the touch panel 310 operates by the capacitance method.

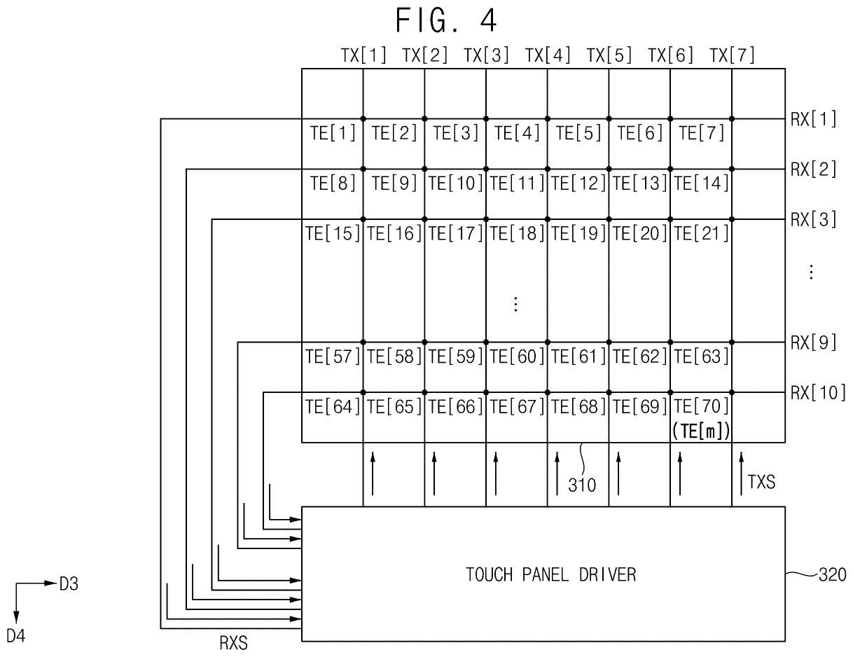

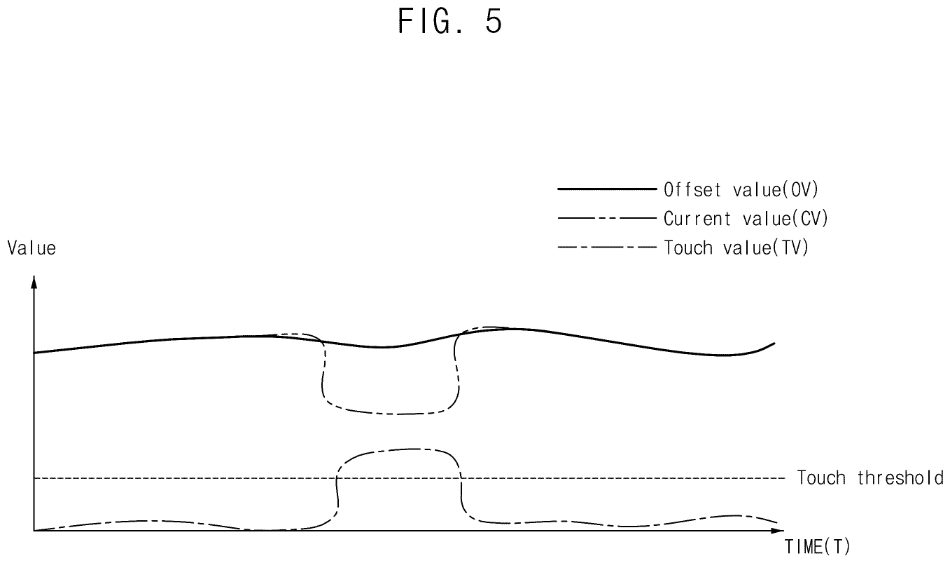

FIG. 4 is a block diagram illustrating the touch sensing device 300 included in the display device 1 of FIG. 1. FIG. 5 is a graph illustrating an offset value OV, a current value CV, and a touch value TV for explaining a criterion for touch recognition.

Referring to FIGS. 4 and 5, the touch sensing device 300 may include the touch panel 310 and the touch panel driver 320.

The touch panel 310 may include first to i-th touch driving lines, where i is an integer equal to or greater than 2 and first to j-th touch sensing lines, where j is an integer equal to or greater than 2. The touch panel 310 may include first to m-th touch electrodes TE[1] to TE[m], where m is an integer equal to or greater than 10. The first to m-th touch electrodes TE[1] to TE[m] may be formed at intersection points at which the first to i-th touch driving lines and the first to j-th touch sensing lines intersect.

For convenience of explanation, it is assumed that the touch panel 310 includes first to seventh touch driving lines TX[1] to TX[7] and first to tenth touch sensing lines RX[1] to RX[10].

In an embodiment, the first to tenth touch sensing wirings RX[1] to RX[10] may extend in a third direction D3, and the first to seventh touch driving wirings TX[1] to TX[7] may extend in a fourth direction D4 different from the third direction D3. For example, the third direction D3 may intersect the fourth direction D4. For example, the third direction D3 may be identical to a first direction D1, and the fourth direction D4 may be identical to a second direction D2.

The touch panel 310 may include the first to 70-th touch electrodes TE[1] to TE[70]. For example, the first touch electrode TE[1] may be formed at an intersection point at which the first touch driving wiring TX[1] and the first touch sensing wiring RX[1] intersect, and the second touch electrode TE[2] may be formed at an intersection point at which the second touch driving wiring TX[2] and the first touch sensing wiring RX[1] intersect. In this way, the 70-th touch electrode TE[70] may be formed at an intersection point at which the seventh touch driving wiring TX[7] and the tenth touch sensing wiring RX[10] intersect.

Each of the first to 70-th touch electrodes TE[1] to TE[70] may generate the touch sensing signal based on the change in the capacitance of the capacitor formed by the touch driving line and the touch sensing line. For example, the first touch electrode TE[1] may generate the touch sensing signal for the first touch electrode TE[1] based on the change in the capacitance of the capacitor formed by the first touch driving line TX[1] and the first touch sensing line RX[1]. The second touch electrode TE[2] may generate the touch sensing signal for the second touch electrode TE[2] based on the change in the capacitance of the capacitor formed by the second touch driving line TX[2] and the first touch sensing line RX[1]. In this way, the 70-th touch electrode TE[70] may generate the touch sensing signal for the 70-th touch electrode TE[70] based on the change in the capacitance of the capacitor formed by the seventh touch driving line TX[7] and the tenth touch sensing line RX[10].

The current value CV is a value for the change in the capacitance of the touch electrode in a current frame. For example, a first current value may be the value for the change in the capacitance of the first touch electrode TE[1] in the current frame, and a second current value may be the value for the change in the capacitance of the second touch electrode TE[2] in the current frame. In this way, a 70-th current value may be the value for the change in the capacitance of the 70-th touch electrode TE[70] in the current frame. When the touch electrode is touched, the capacitance of the touch electrode, which is touched, may decrease. Accordingly, the current value CV of the touch electrode, which is touched, may decrease.

The offset value OV is a value which serves as a criterion for determining whether the touch electrode is touched. For example, a first offset value may be the value which serves as the criterion for determining whether the first touch electrode TE[1] is touched, and a second offset value may be the value which serves as the criterion for determining whether the second touch electrode TE[2] is touched. In this way, a 70-th offset value may be the value which serves as the criterion for determining whether the 70-th touch electrode TE[70] is touched. For example, the first to 70-th offset values for the first to 70-th touch electrodes TE[1] to TE[70] may be stored in a look-up table (LUT).

The touch panel driver 320 may continuously update the offset values OV for each of the first to 70-th touch electrodes TE[1] to TE[70]. The offset value OV may be an average value of current values CV of each of first to l-th frames, where l is an integer equal to or greater than 2. For example, when the touch panel driver 320 updates the offset values OV for each of the first to 70-th touch electrodes TE[1] to TE[70] every 100 frames, the first offset value may be the average value of the current values CV of the first touch electrode TE[1] for each of the first to 100-th frames, and the second offset value may be the average value of the current values CV of the second touch electrode TE[2] for each of the first to 100-th frames. In this way, the 70-th offset value may be the average value of the current values CV of the 70-th touch electrode TE[70] for each of the first to 100-th frames.

The touch value TV is a value obtained by subtracting the current value CV for the touch electrode from the offset value OV for the touch electrode. For example, a first touch value may be the value obtained by subtracting the first current value for the first touch electrode TE[1] from the first offset value for the first touch electrode TE[1], and a second touch value may be the value obtained by subtracting the second current value for the second touch electrode TE[2] from the second offset value for the second touch electrode TE[2]. In this way, a 70-th touch value may be the value obtained by subtracting a 70-th current value for the 70-th touch electrode TE[70] from the 70-th offset value for the 70-th touch electrode TE[70].

When the touch value TV is equal to or greater than a touch threshold, the touch panel driver 320 may recognize the touch for the touch electrode. For example, when the first touch value of the first touch electrode TE[1] is equal to or greater than the touch threshold, the touch panel driver 320 may recognize the touch for the first touch electrode TE[1]. When the second touch value of the second touch electrode TE[2] is equal to or greater than the touch threshold, the touch panel driver 320 may recognize the touch for the second touch electrode TE[2]. In this way, when the 70-th touch value of the 70-th touch electrode TE[70] is equal to or greater than the touch threshold, the touch panel driver 320 may recognize the touch for the 70-th touch electrode TE[70].

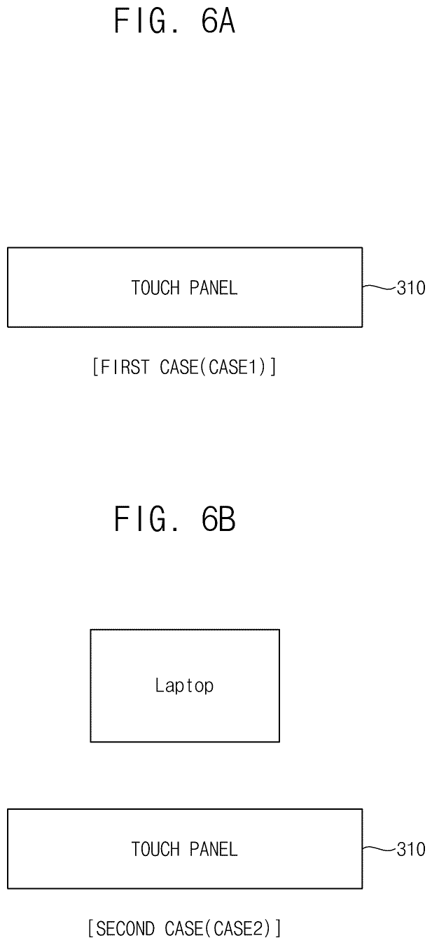

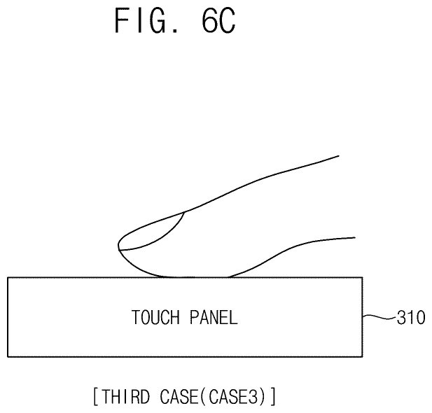

FIG. 6A is a diagram illustrating a first case CASE1 in which the touch panel 310 included in the touch sensing device 300 of FIG. 4 is not touched. FIG. 6B is a diagram illustrating a second case CASE2 in which a conductor (e.g. an unintentional touch-like conductor such as a laptop) approaches the touch panel 310 included in the touch sensing device 300 of FIG. 4. FIG. 6C is a diagram illustrating a third case CASE3 in which the touch panel 310 included in the touch sensing device 300 of FIG. 4 is touched.

Referring to FIGS. 6A to 6C, the first case CASE1 is a case in which the touch panel 310 is not touched, and the second case CASE2 is a case in which the touch panel 310 is not touched and the conductor approaches the touch panel 310, and the third case CASE3 is a case in which the touch panel 310 is touched. For example, the second case CASE2 may be a case in which a laptop approaches the touch panel 310. For example, the second case CASE2 may be a case in which a palm or an arm of the user of the display device 1 approaches the touch panel 310. For example, in the third case CASE3, the touch panel 310 may be touched by a finger of the user of the display device 1.

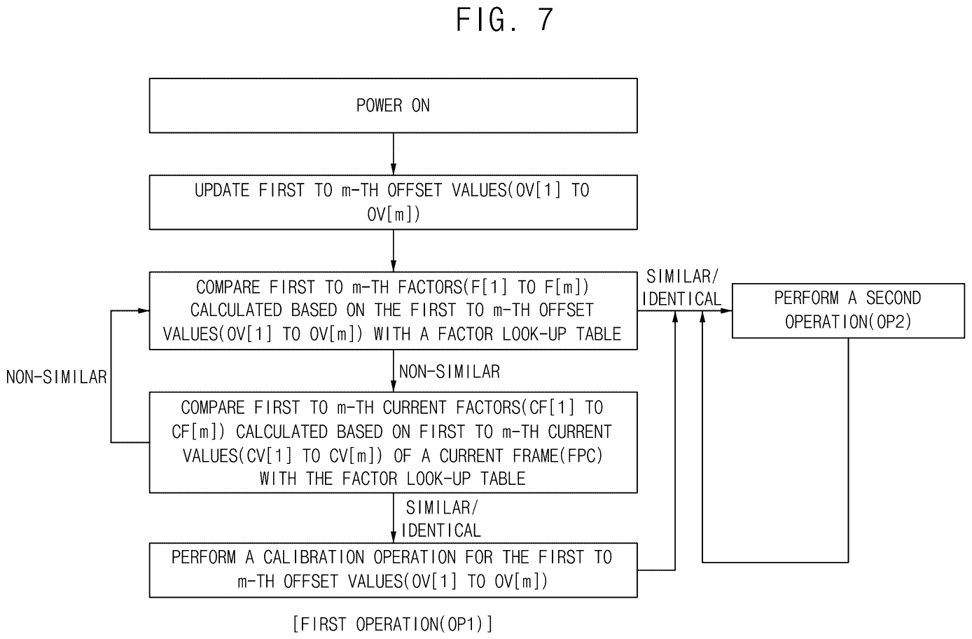

FIG. 7 is a flowchart illustrating a first operation OP1 of the touch panel driver 320 included in the touch sensing device 300 of FIG. 4.

Referring to FIG. 7, when the touch sensing device 300 is powered on, the touch panel driver 320 may perform the first operation OP1.

When the touch sensing device 300 is powered on, the touch panel driver 320 may update the first to m-th offset values OV[1] to OV[m] for the first to m-th touch electrodes TE[1] to TE[m].

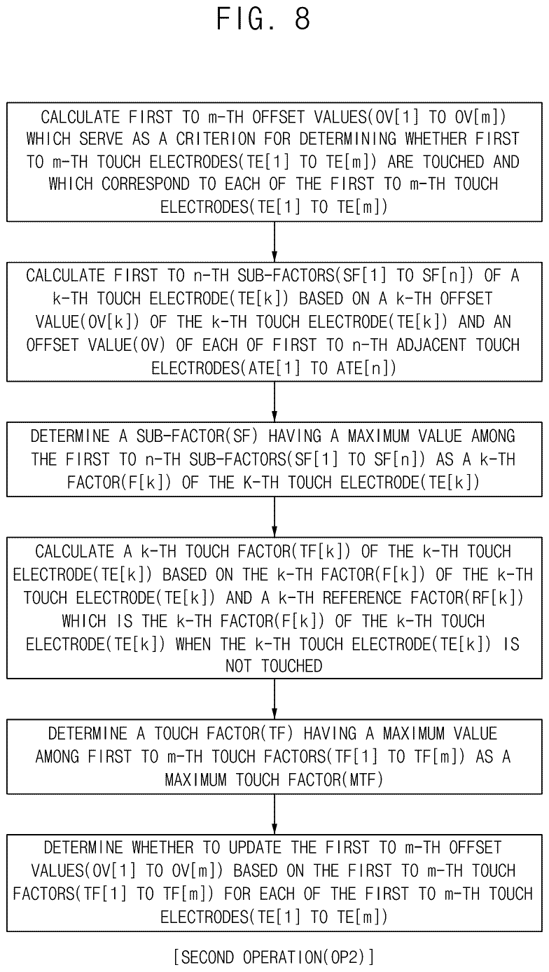

The touch panel driver 320 may calculate first to m-th factors F[1] to F[m] based on the first to m-th offset values OV[1] to OV[m] which are updated. The first to m-th factors F[1] to F[m] will be described in detail with reference to FIGS. 8 to 13.

The touch panel driver 320 may compare the first to m-th factors F[1] to F[m] with a factor look-up table (FLUT). The FLUT stores reference values for determining whether the first to m-th offset values OV[1] to OV[m] are normally updated.

When the first to m-th factors F[1] to F[m] and the reference values stored in the FLUT are similar or identical, the touch panel driver 320 may perform a second operation OP2.

When the first to m-th factors F[1] to F[m] and the reference values stored in the FLUT are not similar, the touch panel driver 320 may calculate first to m-th current factors CF[1] to CF[m] based on the first to m-th current values CV[1] to CV[m] for the first to m-th touch electrodes TE[1] to TE[m] of the current frame FPC and may compare the first to m-th current factors CF[1] to CF[m] with the FLUT. The first to m-th current factors CF[1] to CF[m] may be calculated in the same way as the first to m-th factors F[1] to F[m].

When the first to m-th current factors CF[1] to CF[m] for the first to m-th touch electrodes TE[1] to TE[m] of the current frame FPC and the reference values stored in the FLUT are similar or identical, the touch panel driver 320 may perform a calibration operation for initializing the first to m-th offset values OV[1] to OV[m]. That is, the first to m-th offset values OV[1] to OV[m] may be initialized by the calibration operation. After the touch panel driver 320 performs the calibration operation, the touch panel driver 320 may perform the second operation OP2.

When the first to m-th current factors CF[1] to CF[m] for the first to m-th touch electrodes TE[1] to TE[m] of the current frame FPC and the reference values stored in the FLUT are not similar, the touch panel driver 320 may compare the first to m-th factors F[1] to F[m] with the FLUT again.

The touch panel driver 320 may perform the second operation OP2 for each frame. That is, the touch panel driver 320 may determine a type of touch for each frame and may determine whether to update the first to m-th offset values OV[1] to OV[m].

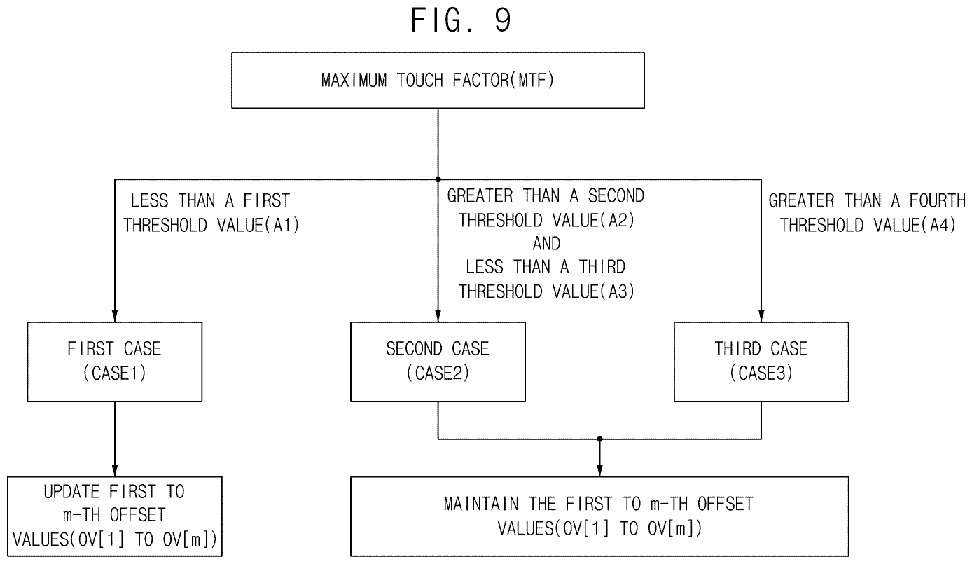

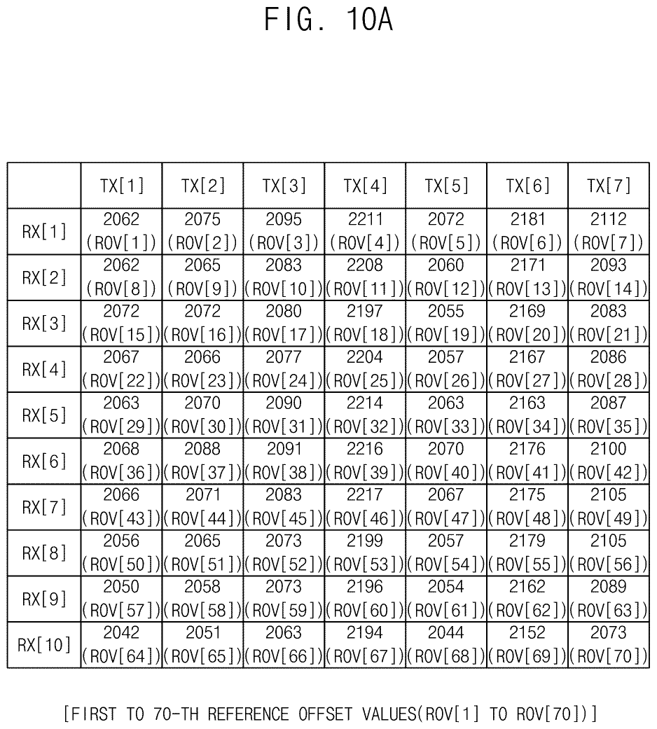

FIG. 8 is a flowchart illustrating the second operation OP2 of the touch panel driver 320 included in the touch sensing device 300 of FIG. 4. FIG. 9 is a diagram illustrating that the touch panel driver 320 included in the touch sensing device 300 of FIG. 4 distinguishes the first to third cases CASE1 to CASE3 based on threshold values.

Referring to FIG. 8, after the touch panel driver 320 performs the first operation OP1, the touch panel driver 320 may perform the second operation OP2.

The touch panel driver 320 may calculate the first to m-th offset values OV[1] to OV[m] which serve as the criteria for determining whether the first to m-th touch electrodes TE[1] to TE[m] are touched and which correspond to each of the first to m-th touch electrodes TE[1] to TE[m].

For the first to m-th touch electrodes TE[1] to TE[m], the touch panel driver 320 may calculate first to n-th sub-factors SF[1] to SF[n] of a k-th touch electrode TE[k], where k is an integer equal to or greater than 1 and less than or equal to m, based on a k-th offset value OV[k] of the k-th touch electrode TE[k] and an offset value OV of each of first to n-th adjacent touch electrodes ATE[1] to ATE[n], where n is an integer equal to or greater than 2 and less than or equal to 4.

For example, the touch panel driver 320 may calculate the first to fourth sub-factors SF[1] to SF[4] of the tenth touch electrode TE[10] based on the tenth offset value OV[10] of the tenth touch electrode TE[10] and the offset value OV of each of first to fourth adjacent touch electrodes ATE[1] to ATE[4] which are adjacent to the tenth touch electrode TE[10]. The first adjacent touch electrode ATE[1] may be the third touch electrode TE[3], the second adjacent touch electrode ATE[2] may be the ninth touch electrode TE[9], the third adjacent touch electrode ATE[3] may be the seventeenth touch electrode TE[17], and the fourth adjacent touch electrode ATE[4] may be the eleventh touch electrode TE[11]. The touch panel driver 320 may calculate the first sub-factor SF[1] based on the tenth offset value OV[10] of the tenth touch electrode TE[10] and the third offset value OV[3] of the third touch electrode TE[3], may calculate the second sub-factor SF[2] based on the tenth offset value OV[10] of the tenth touch electrode TE[10] and the ninth offset value OV[9] of the ninth touch electrode TE[9], may calculate the third sub-factor SF[3] based on the tenth offset value OV[10] of the tenth touch electrode TE[10] and the seventeenth offset value OV[17] of the seventeenth touch electrode TE[17], and may calculate the fourth sub-factor SF[4] based on the tenth offset value OV[10] of the tenth touch electrode TE[10] and the eleventh offset value OV[11] of the eleventh touch electrode TE[11].

For example, the touch panel driver 320 may calculate the first to third sub-factors SF[1] to SF[3] of the second touch electrode TE[2] based on the second offset value OV[2] of the second touch electrode TE[2] and the offset value OV of each of the first to third adjacent touch electrodes ATE[1] to ATE[3] which are adjacent to the second touch electrode TE[2]. The first adjacent touch electrode ATE[1] may be the first touch electrode TE[1], the second adjacent touch electrode ATE[2] may be the tenth touch electrode TE[10], and the third adjacent touch electrode ATE[3] may be a third touch electrode TE[3]. The touch panel driver 320 may calculate the first sub-factor SF[1] based on the second offset value OV[2] of the second touch electrode TE[2] and the first offset value OV[1] of the first touch electrode TE[1], may calculate the second sub-factor SF[2] based on the second offset value OV[2] of the second touch electrode TE[2] and the ninth offset value OV[9] of the ninth touch electrode TE[9], and may calculate the third sub-factor SF[3] based on the second offset value OV[2] of the second touch electrode TE[2] and the third offset value OV[3] of the third touch electrode TE[3].

For example, the touch panel driver 320 may calculate the first and second sub-factors SF[1] and SF[2] of the first touch electrode TE[1] based on the first offset value OV[1] of the first touch electrode TE[1] and the offset value OV of each of the first and second adjacent touch electrodes ATE[1] and ATE[2] which are adjacent to the first touch electrode TE[1]. The first adjacent touch electrode ATE[1] may be the eighth touch electrode TE[8], and the second adjacent touch electrode ATE[2] may be the second touch electrode TE[2]. The touch panel driver 320 may calculate the first sub-factor SF[1] based on the first offset value OV[1] of the first touch electrode TE[1] and the eighth offset value OV[8] of the eighth touch electrode TE[8] and may calculate the second sub-factor SF[2] based on the first offset value OV[1] of the first touch electrode TE[1] and the second offset value OV[2] of the second touch electrode TE[2].

For the first to m-th touch electrodes TE[1] to TE[m], the touch panel driver 320 may determine a sub-factor having a maximum value among the first to n-th sub-factors SF[1] to SF[n] as a k-th factor F[k] of the k-th touch electrode TE[k]. That is, the touch panel driver 320 may calculate first to m-th factors F[1] to F[m] for each of the first to m-th touch electrodes TE[1] to TE[m].

For the first to m-th touch electrodes TE[1] to TE[m], the touch panel driver 320 may calculate a k-th touch factor TF[k] of the k-th touch electrode TE[k] based on the k-th factor F[k] of the k-th touch electrode TE[k] and a k-th reference factor RF[k] which is the k-th factor F[k] of the k-th touch electrode TE[k] when the k-th touch electrode TE[k] is not touched. That is, the touch panel driver 320 may calculate first to m-th touch factors TF[1] to TF[m] for each of the first to m-th touch electrodes TE[1] to TE[m].

The touch panel driver 320 may determine the touch factor TF having a maximum value among the first to m-th touch factors TF[1] to TF[m] as a maximum touch factor MTF.

The touch panel driver 320 may determine whether to update the first to m-th offset values OV[1] to OV[m] for each of the first to m-th touch electrodes TE[1] to TE[m] based on the maximum touch factor MTF and first to fourth threshold values A1 to A4.

The first threshold value A1 may be less than the second threshold value A2, the second threshold value A2 may be less than the third threshold value A3, and the third threshold value A3 may be less than the fourth threshold value A4.

The touch panel driver 320 may determine the touch type as the first case CASE1 when the maximum touch factor MTF is less than the first threshold value A1. When the touch type is the first case CASE1, the touch panel driver 320 may update the first to m-th offset values OV[1] to OV[m] for the first to m-th touch electrodes TE[1] to TE[m].

The touch panel driver 320 may determine the touch type as the second case CASE2 when the maximum touch factor MTF is greater than the second threshold value A2, which is greater than the first threshold value A1, and less than the third threshold value A3, which is greater than the second threshold value A2. When the touch type is the second case CASE2, the touch panel driver 320 may not update the first to m-th offset values OV[1] to OV[m] for the first to m-th touch electrodes TE[1] to TE[m]. That is, the first to m-th offset values OV[1] to OV[m] may be maintained.

The touch panel driver 320 may determine the touch type as the third case CASE3 when the maximum touch factor MTF is greater than the fourth threshold value A4 which is greater than a third threshold value A3. When the touch type is the third case CASE3, the touch panel driver 320 may not update the first to m-th offset values OV[1] to OV[m] for the first to m-th touch electrodes TE[1] to TE[m]. That is, the first to m-th offset values OV[1] to OV[m] may be maintained.

The touch panel driver 320 calculates the first to m-th factors F[1] to F[m] for the first to m-th touch electrodes TE[1] to TE[m] based on the first to m-th offset values OV[1] to OV[m], calculates the first to m-th touch factors TF[1] to TF[m] based on the first to m-th factors F[1] to F[m] and the first to m-th reference factors RF[1] to RF[m], determines the maximum touch factor MTF based on the first to m-th touch factors TF[1] to TF[m], and compares the maximum touch factor MTF with the first to fourth threshold values A1 to A4, so that the touch panel driver 320 may accurately distinguish the first to third cases CASE1 to CASE3. The first to third cases CASE1 to CASE3 may be accurately distinguished, so that the first to m-th offset values OV[1] to OV[m] may be normally updated. The first to m-th offset values OV[1] to OV[m] are normally updated, so that the touch sensing device 300 may accurately recognize the touch of the user of the display device 1. That is, reliability of the touch sensing device 300 may be improved and reliability of the display device 1 including the touch sensing device 300 may be improved.

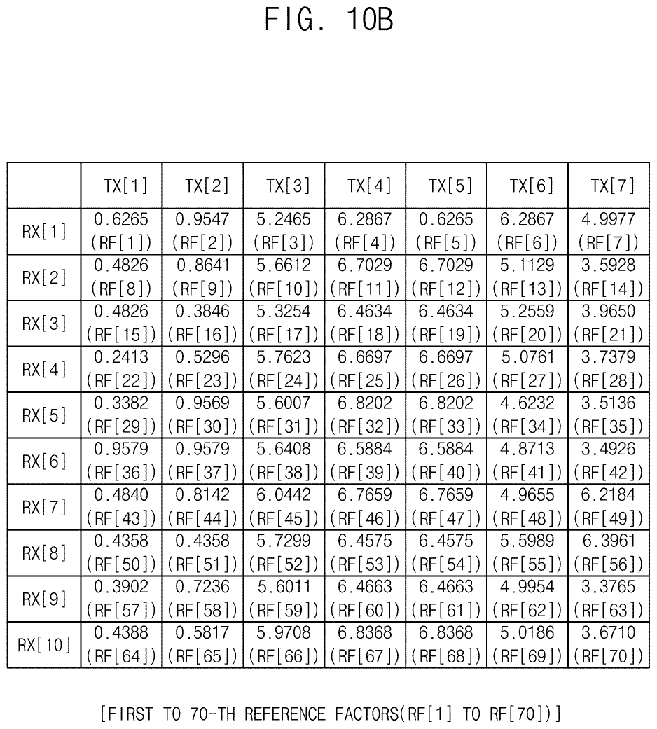

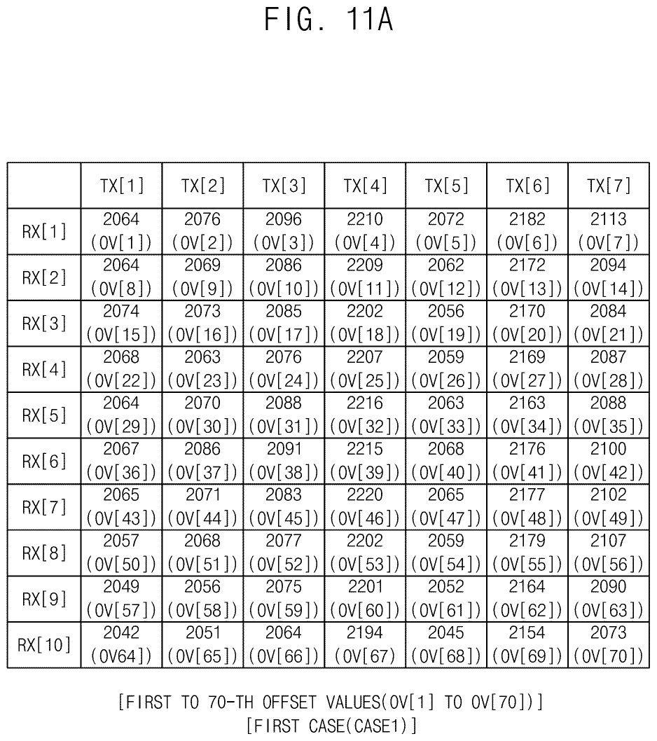

FIG. 10A is a table illustrating the reference offset values corresponding to each of the first to m-th touch electrodes TE[1] to TE[m] of the touch panel 310 included in the touch sensing device 300 of FIG. 4. FIG. 10B is a table illustrating the reference factors for each of the first to m-th touch electrodes TE[1] to TE[m] of the touch panel 310 included in the touch sensing device 300 of FIG. 4.

Referring to FIGS. 10A and 10B, the first to m-th reference offset values corresponding to the first to m-th touch electrodes TE[1] to TE[m] may be stored in a look-up table (LUT).

The reference offset value is the offset value for the touch electrode when the touch electrode is not touched. For example, the first reference offset value ROV[1] is the first offset value OV[1] for the first touch electrode TE[1] when the first touch electrode TE[1] is not touched, and the second reference offset value ROV[2] is the second offset value OV[2] for the second touch electrode TE[2] when the second touch electrode TE[2] is not touched. In this way, the m-th reference offset value is the m-th offset value OV[m] for the m-th touch electrode TE[m] when the m-th touch electrode TE[m] is not touched.

In an embodiment, after the touch panel driver 320 performs the first operation OP1, the first to m-th touch electrodes TE[1] to TE[m] may not be touched. Accordingly, after the touch panel driver 320 performs the first operation OP1, the touch panel driver 320 may store the first to m-th offset values OV[1] to OV[m] as the first to m-th reference offset values in the LUT.

For convenience of explanation, it is assumed that the touch panel 310 includes the first to 70-th touch electrodes TE[1] to TE[70].

The first to 70-th reference offset values ROV[1] to ROV[70] corresponding to the first to 70-th touch electrodes TE[1] to TE[70] may be stored in the LUT.

For the first to seventieth touch electrodes TE[1] to TE[70], the touch panel driver 320 may calculate the first to n-th reference sub-factors of the k-th touch electrode TE[k] based on the k-th reference offset value ROV[k] of the k-th touch electrode TE[k] and the reference offset values ROV of each of the first to n-th adjacent touch electrodes ATE[1] to ATE[n], which are adjacent to the k-th touch electrode TE[k].

The touch panel driver 320 may determine the reference sub-factor having the maximum value among the first to n-th reference sub-factors of the k-th touch electrode TE[k] as the k-th reference factor RF[k].

An a-th reference sub-factor of the k-th touch electrode TE[k], where a is an integer equal to or greater than 1 and equal to or less than n, may be calculated by [Equation 1] “RSF[a]=100−(ROVS/ROVG)*100”, where, RSF[a] denotes the a-th reference sub-factor of the k-th touch electrode TE[k], ROVS denotes a smaller one of the k-th reference offset value ROV[k] of the k-th touch electrode TE[k] and the reference offset value ROV of the a-th adjacent touch electrode ATE[a] adjacent to the k-th touch electrode TE[k], and ROVG denotes a greater one of the k-th reference offset value ROV[k] of the k-th touch electrode TE[k] and the reference offset value ROV of the a-th adjacent touch electrode ATE[a].

For example, the tenth reference offset value ROV[10] of the tenth touch electrode TE[10] may be 2083. The first adjacent touch electrode ATE[1] of the tenth touch electrode TE[10] may be the third touch electrode TE[3], the third reference offset value ROV[3] of the third touch electrode TE[3] may be 2095, and the first reference sub-factor may be about 0.5728 by the [Equation 1].

The second adjacent touch electrode ATE[2] of the tenth touch electrode TE[10] may be the ninth touch electrode TE[9], the ninth reference offset value ROV[9] of the ninth touch electrode TE[9] may be 2065, and the second reference sub-factor may be about 0.8641 by the [Equation 1].

The third adjacent touch electrode ATE[3] of the tenth touch electrode TE[10] may be the seventeenth touch electrode TE[17], the seventeenth reference offset value ROV[17] of the seventeenth touch electrode TE[17] may be 2080, and the third reference sub-factor may be about 0.1440 by the [Equation 1].

The fourth adjacent touch electrode ATE[4] of the tenth touch electrode TE[10] may be the eleventh touch electrode TE[11], the eleventh reference offset value ROV[11] of the eleventh touch electrode TE[11] may be 2208, and the fourth reference sub-factor may be about 5.6612 by the [Equation 1].

Accordingly, the fourth reference sub-factor having the maximum value among the first to fourth reference sub-factors of the tenth touch electrode TE[10] may be determined as the tenth reference factor RF[10] of the tenth touch electrode TE[10]. That is, the tenth reference factor RF[10] of the tenth touch electrode TE[10] may be about 5.6612.

That is, the touch panel driver 320 may calculate the first to seventieth reference factors RF[1] to RF[70] for the first to seventieth touch electrodes TE[1] to TE[70]. In addition, the first to seventieth reference factors RF[1] to RF[70] for the first to seventieth touch electrodes TE[1] to TE[70] may be stored in the LUT.

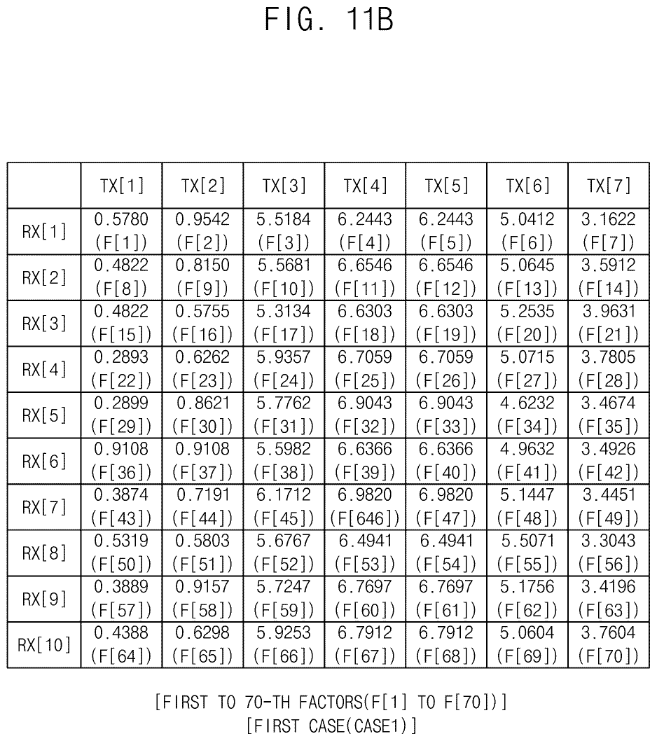

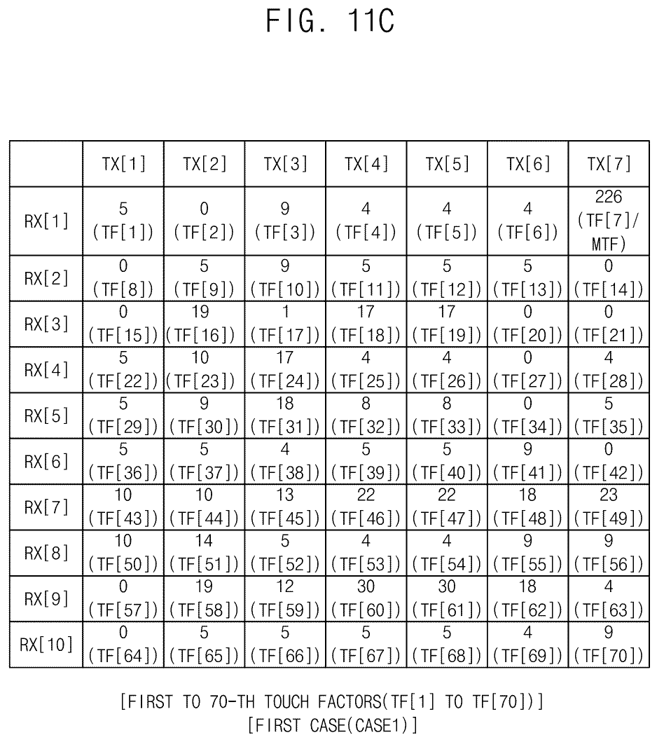

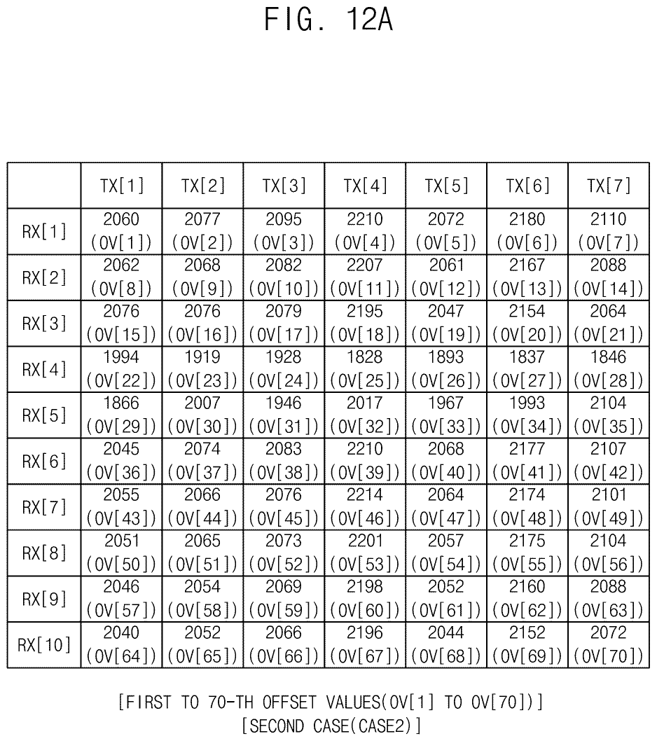

FIG. 11A is a table illustrating the first to m-th offset values OV[1] to OV[m] corresponding to each of the first to m-th touch electrodes TE[1] to TE[m] of the touch panel 310 included in the touch sensing device 300 of FIG. 4 in the first case CASE1. FIG. 11B is a table illustrating the first to m-th factors F[1] to F[m] for each of the first to m-th touch electrodes TE[1] to TE[m] of the touch panel 310 included in the touch sensing device 300 of FIG. 4 in the first case CASE1. FIG. 11C is a table illustrating the first to m-th touch factors TF[1] to TF[m] for each of the first to m-th touch electrodes TE[1] to TE[m] of the touch panel 310 included in the touch sensing device 300 of FIG. 4 in the first case CASE1.

Referring to FIGS. 11A to 11C, the touch panel driver 320 may calculate the first to m-th factors F[1] to F[m] for each of the first to m-th touch electrodes TE[1] to TE[m] based on the first to m-th offset values OV[1] to OV[m] corresponding to the first to m-th touch electrodes TE[1] to TE[m], may calculate the first to m-th touch factors TF[1] to TF[m] for each of the first to m-th touch electrodes TE[1] to TE[m] based on the first to m-th factors F[1] to F[m], and may determine whether to update the first to m-th offset values OV[1] to OV[m] based on the first to m-th touch factors TF[1] to TF[m].

The touch panel driver 320 may calculate the first to n-th sub-factors SF[1] to SF[n] of the k-th touch electrode TE[k] based on the k-th offset value OV[k] of the k-th touch electrode TE[k] and the offset values OV of each of the first to n-th adjacent touch electrodes ATE[1] to ATE[n] adjacent to the k-th touch electrode TE[k].

The touch panel driver 320 may determine the sub-factor having the maximum value among the first to n-th sub-factors SF[1] to SF[n] of the k-th touch electrode TE[k] as the k-th factor F[k].

The a-th sub-factor SF[a] of the k-th touch electrode TE[k] may be calculated by [Equation 2], “SF[a]=100−(OVS/OVG)*100”, where, SF[a] denotes the a-th sub-factor of the k-th touch electrode TE[k], OVS denotes a smaller one of the k-th offset value OV[k] of the k-th touch electrode TE[k] and the offset value OV of the a-th adjacent touch electrode ATE[a] adjacent to the k-th touch electrode TE[k], and OVG denotes a greater one of the k-th offset value OV[k] of the k-th touch electrode TE[k] and the offset value OV of the a-th adjacent touch electrode ATE[a].

In this way, the touch panel driver 320 may calculate the first to m-th factors F[1] to F[m] for each of the first to m-th touch electrodes TE[1] to TE[m].

For the first to m-th touch electrodes TE[1] to TE[m], the touch panel driver 320 may calculate the k-th touch factor TF[k] of the k-th touch electrode TE[k] based on the k-th reference factor RF[k] of the k-th touch electrode TE[k] and the k-th factor F[k] of the k-th touch electrode TE[k].

The k-th touch factor TF[k] of the k-th touch electrode TE[k] may be calculated by [Equation 3], “TF[k]=|RF[k]−F[k]|*100”, where, TF[k] denotes the k-th touch factor TF[k] of the k-th touch electrode TE[k], RF[k] denotes the k-th reference factor RF[k] of the k-th touch electrode TE[k], and F[k] denotes the k-th factor F[k] of the k-th touch electrode TE[k].

In this way, the touch panel driver 320 may calculate the first to m-th touch factors TF[1] to TF[m] for each of the first to m-th touch electrodes TE[1] to TE[m].

The touch panel driver 320 may determine the touch factor TF having the maximum value among the first to m-th touch factors TF[1] to TF[m] for the first to m-th touch electrodes TE[1] to TE[m] as the maximum touch factor MTF.

The touch panel driver 320 may determine whether to update the first to m-th offset values OV[1] to OV[m] based on the maximum touch factor MTF and the threshold values. The touch panel driver 320 may determine whether to update the first to m-th offset values OV[1] to OV[m] based on the maximum touch factor MTF and the first to fourth threshold values A1 to A4.

In an embodiment, the touch panel 310 may include the first to 70-th touch electrodes TE[1] to TE[70], the first threshold value A1 may be 100, the second threshold value A2 may be 600, the third threshold value A3 may be 1200, and the fourth threshold value A4 may be 2000.

The touch panel driver 320 may calculate the first to 70-th factors F[1] to F[70] for each of the first to 70-th touch electrodes.

For example, the seventh offset value OV[7] of the seventh touch electrode TE[7] may be 2113. The first adjacent touch electrode ATE[1] of the seventh touch electrode TE[7] may be the sixth touch electrode TE[6], the sixth offset value OV[6] of the sixth touch electrode TE[6] may be 2182, and the first sub-factor SF[1] may be about 3.1622 by the [Equation 2].

The second adjacent touch electrode ATE[2] of the seventh touch electrode TE[7] may be the fourteenth touch electrode TE[14], the fourteenth offset value OV[14] of the fourteenth touch electrode TE[14] may be 2094, and the second sub-factor SF[2] may be about 0.8992 by the [Equation 2].

Accordingly, the first sub-factor SF[1] having the maximum value among the first and second sub-factors SF[1] and SF[2] of the seventh touch electrode TE[7] may be determined as the seventh factor F[7] of the seventh touch electrode TE[7]. That is, the seventh factor F[7] of the seventh touch electrode TE[7] may be about 3.1622.

The touch panel driver 320 may calculate the first to 70-th touch factors TF[1] to TF[70] for each of the first to 70-th touch electrodes TE[1] to TE[70]. For example, the seventh reference factor RF[7] of the seventh touch electrode TE[7] may be about 0.8996, and the seventh factor F[7] of the seventh touch electrode TE[7] may be about 3.1622. The seventh touch factor TF[7] of the seventh touch electrode TE[7] may be about 226 by the [Equation 3].

The touch panel driver 320 may determine the touch factor TF having the maximum value among the first to 70-th touch factors TF[1] to TF[70] as the maximum touch factor MTF. For example, the seventh touch factor TF[7] among the first to 70-th touch factors TF[1] to TF[70] for the first to 70-th touch electrodes TE[1] to TE[70] may have the maximum value. Accordingly, the seventh touch factor TF[7] may be the maximum touch factor MTF. The seventh touch factor TF[7] may be about 226.

When the maximum touch factor MTF is the seventh touch factor TF[7], and the seventh touch factor TF[7] is about 226, the maximum touch factor MTF is less than the first threshold value A1, so that the touch panel driver 320 may determine the touch type as the first case CASE1. Accordingly, the touch panel driver 320 may update the first to 70-th offset values OV[1] to OV[70].

The touch panel driver 320 calculates the first to m-th factors F[1] to F[m] for the first to m-th touch electrodes TE[1] to TE[m] based on the first to m-th offset values OV[1] to OV[m], calculates the first to m-th touch factors TF[1] to TF[m] based on the first to m-th factors F[1] to F[m] and the first to m-th reference factors RF[1] to RF[m], determines the maximum touch factor MTF based on the first to m-th touch factors TF[1] to TF[m], and compares the maximum touch factor MTF with the first to fourth threshold values A1 to A4, so that the first to third cases CASE1 to CASE3 may be accurately distinguished. The first to third cases CASE1 to CASE3 are accurately distinguished, so that the first to m-th offset values OV[1] to OV[m] may be normally updated. The first to m-th offset values OV[1] to OV[m] are normally updated, so that the touch sensing device 300 may accurately recognize the touch of the user of the display device 1. That is, the reliability of the touch sensing device 300 may be improved and the reliability of the display device 1 including the touch sensing device 300 may be improved.

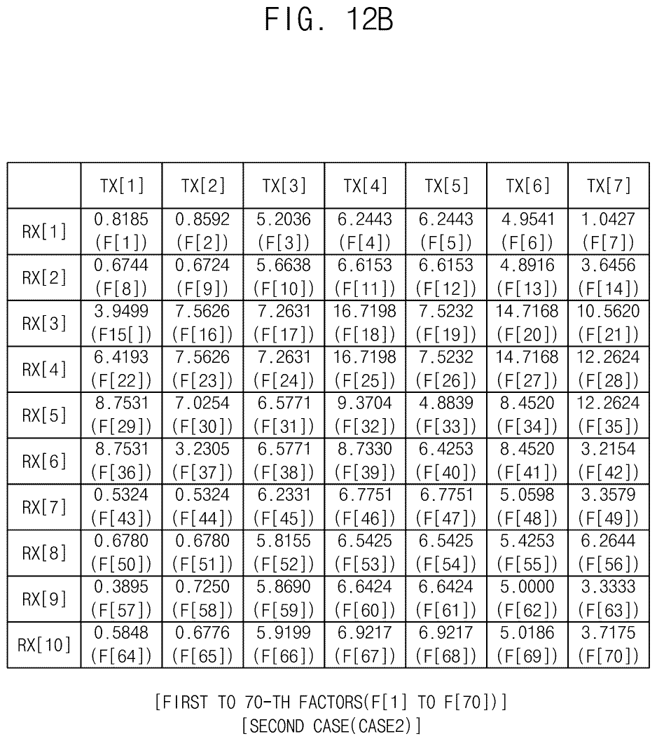

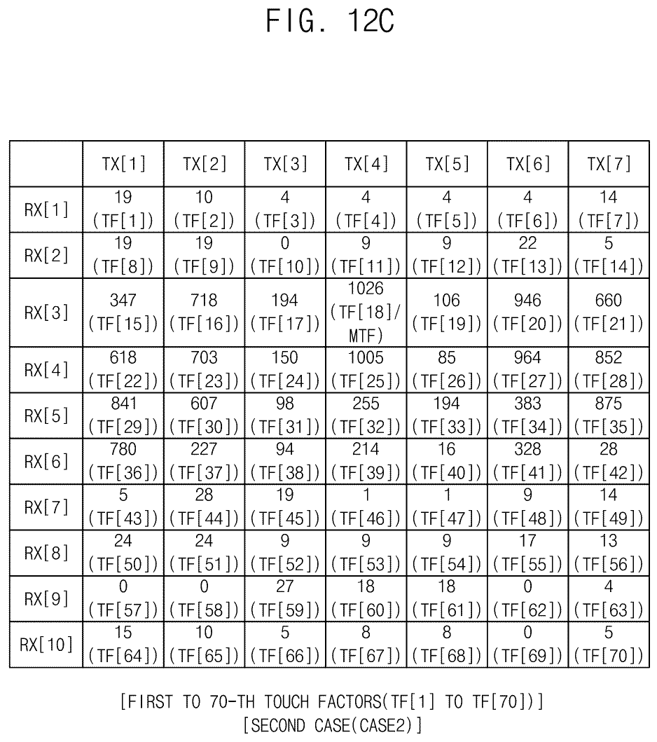

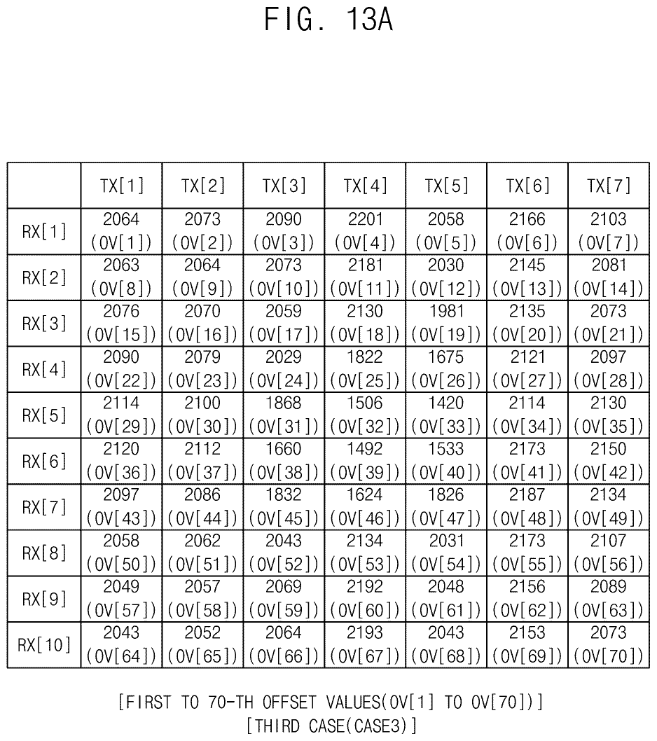

FIG. 12A is a table illustrating first to m-th offset values OV[1] to OV[m] corresponding to each of the first to m-th touch electrodes TE[1] to TE[m] of the touch panel 310 included in the touch sensing device 300 of FIG. 4 in the second case CASE2. FIG. 12B is a table illustrating first to m-th factors F[1] to F[m] for each of the first to m-th touch electrodes TE[1] to TE[m] of the touch panel 310 included in the touch sensing device 300 of FIG. 4 in the second case CASE2. FIG. 12C is a table illustrating first to m-th touch factors TF[1] to TF[m] for each of the first to m-th touch electrodes TE[1] to TE[m] of the touch panel 310 included in the touch sensing device 300 of FIG. 4 in the second case CASE2.

Referring to FIGS. 12A to 12C, the touch panel driver 320 may calculate the first to m-th factors F[1] to F[m] for each of the first to m-th touch electrodes TE[1] to TE[m] based on the first to m-th offset values OV[1] to OV[m], may calculate the first to m-th touch factors TF[1] to TF[m] for each of the first to m-th touch electrodes TE[1] to TE[m] based on the first to m-th factors F[1] to F[m], and may determine whether to update the first to m-th offset values OV[1] to OV[m] based on the first to m-th touch factors TF[1] to TF[m].

The operation of the touch panel driver 320 is substantially the same as the operation of the touch panel driver 320 of FIGS. 11A to 11C except for the first to m-th offset values OV[1] to OV[m]. Thus, the same reference numerals will be used to refer to the same or like parts as those described in the previous embodiment of FIGS. 11A to 11C and any repetitive explanation concerning the above elements will be omitted.

In an embodiment, the touch panel 310 may include the first to 70-th touch electrodes TE[1] to TE[70], the first threshold value A1 may be 100, the second threshold value A2 may be 600, the third threshold value A3 may be 1200, and the fourth threshold value A4 may be 2000.

The touch panel driver 320 may calculate the first to 70-th factors F[1] to F[70] for the first to 70-th touch electrodes TE[1] to TE[70].

For example, the eighteenth offset value OV[18] of the eighteenth touch electrode TE[18] may be 2195. The first adjacent touch electrode ATE[1] of the eighteenth touch electrode TE[18] may be the eleventh touch electrode TE[11], the eleventh offset value OV[11] of the eleventh touch electrode TE[11] may be 2207, and the first sub-factor SF[1] may be about 0.5437 by the [Equation 2].

The second adjacent touch electrode ATE[2] of the eighteenth touch electrode TE[18] may be the seventeenth touch electrode TE[17], the seventeenth offset value OV[17] of the seventeenth touch electrode TE[17] may be 2079, and the second sub-factor SF[2] may be about 5.2847 by the [Equation 2].

The third adjacent touch electrode ATE[3] of the eighteenth touch electrode TE[18] may be the 25-th touch electrode TE[25], the 25-th offset value OV[25] of the 25-th touch electrode TE[25] may be 1828, and the third sub-factor SF[3] may be about 16.7198 by the [Equation 2].

The fourth adjacent touch electrode ATE[4] of the eighteenth touch electrode TE[18] may be the nineteenth touch electrode TE[19], the nineteenth offset value OV[19] of the nineteenth touch electrode TE[19] may be 2047, and the fourth sub-factor SF[4] may be about 6.7426 by the [Equation 2].

Accordingly, the third sub-factor SF[3] having the maximum value among the first to fourth sub-factors SF[1] to SF[4] of the eighteenth touch electrode TE[18] may be determined as the eighteenth factor F[18] of the eighteenth touch electrode TE[18]. That is, the eighteenth factor F[18] of the eighteenth touch electrode TE[18] may be about 16.7198.

The touch panel driver 320 may calculate the first to 70-th touch factors TF[1] to TF[70] for each of the first to 70-th touch electrodes TE[1] to TE[70]. For example, the eighteenth reference factor RF[18] of the eighteenth touch electrode TE[18] may be about 6.4634 and the eighteenth factor F[18] of the eighteenth touch electrode TE[18] may be about 16.7198. The eighteenth touch factor TF[18] of the eighteenth touch electrode TE[18] may be about 1026 by the [Equation 3].

The touch panel driver 320 may determine the touch factor TF having the maximum value among the first to 70-th touch factors TF[1] to TF[70] as the maximum touch factor MTF. For example, the eighteenth touch factor TF[18] among the first to 70-th touch factors TF[1] to TF[70] for the first to 70-th touch electrodes TE[1] to TE[70] may have the maximum value. Accordingly, the eighteenth touch factor TF[18] may be the maximum touch factor MTF. The eighteenth touch factor TF[18] may be about 1026.

When the maximum touch factor MTF is the eighteenth touch factor TF[18] and the eighteenth touch factor TF[18] is about 1026, the maximum touch factor MTF is greater than the second threshold value A2 and less than the third threshold value A3, so that the touch panel driver 320 may determine the touch type as the second case CASE2. Accordingly, the touch panel driver 320 may not update the first to 70-th offset values OV[1] to OV[70].

The touch panel driver 320 calculates the first to m-th factors F[1] to F[m] for the first to m-th touch electrodes TE[1] to TE[m] based on the first to m-th offset values OV[1] to OV[m], calculates the first to m-th touch factors TF[1] to TF[m] based on the first to m-th factors F[1] to F[m] and the first to m-th reference factors RF[1] to RF[m], determines the maximum touch factor MTF based on the first to m-th touch factors TF[1] to TF[m], and compares the maximum touch factor MTF with the first to fourth threshold values A1 to A4, so that the touch panel driver 320 may accurately distinguish the first to third cases CASE1 to CASE3. The first to third cases CASE1 to CASE3 are accurately distinguished, so that the first to m-th offset values OV[1] to OV[m] may be normally updated. The first to m-th offset values OV[1] to OV[m] are normally updated, so that the touch sensing device 300 may accurately recognize the touch of the user of the display device 1. That is, the reliability of the touch sensing device 300 may be improved and the reliability of the display device 1 including the touch sensing device 300 may be improved.

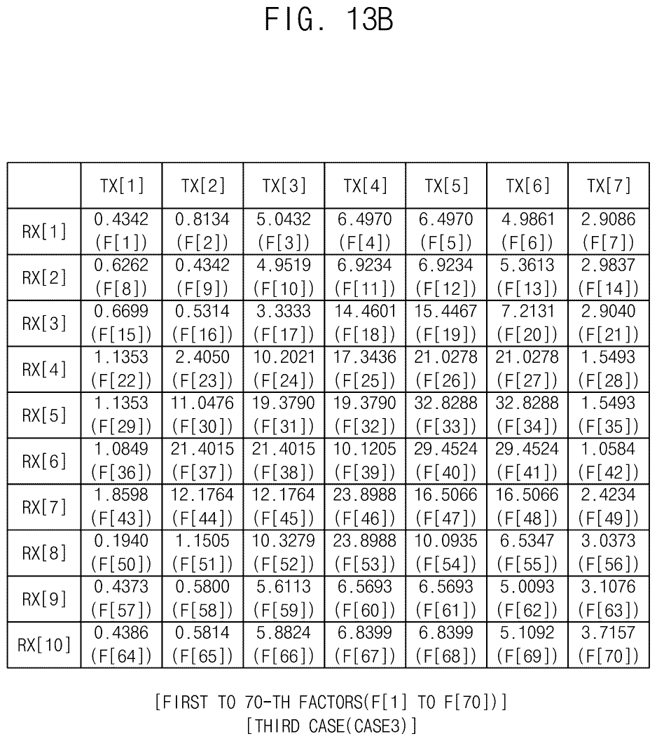

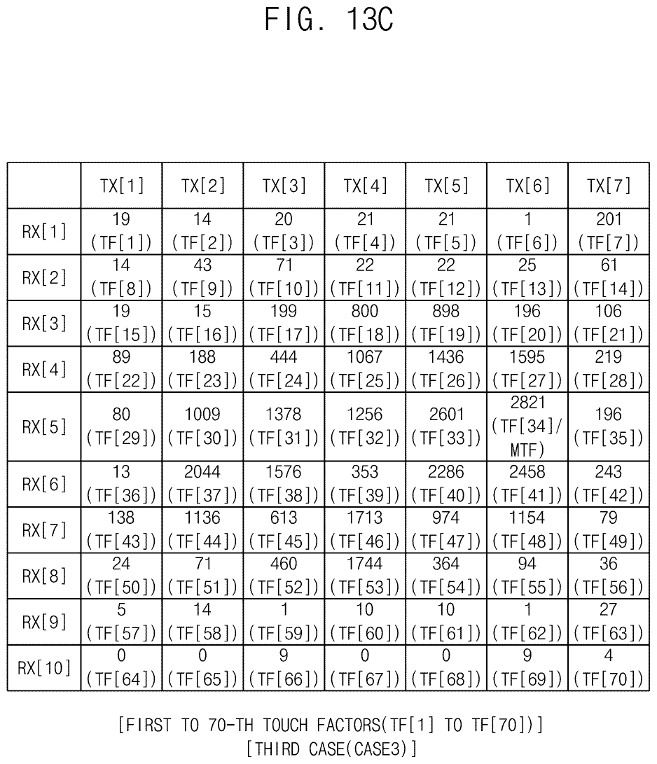

FIG. 13A is a table illustrating the first to m-th offset values OV[1] to OV[m] corresponding to each of the first to m-th touch electrodes TE[1] to TE[m] of the touch panel 310 included in the touch sensing device 300 of FIG. 4 in the third case CASE3. FIG. 13B is a table illustrating first to m-th factors F[1] to F[m] for each of the first to m-th touch electrodes TE[1] to TE[m] of the touch panel 310 included in the touch sensing device 300 of FIG. 4 in the third case CASE3. FIG. 13C is a table illustrating first to m-th touch factors TF[1] to TF[m] for each of the first to m-th touch electrodes TE[1] to TE[m] of the touch panel 310 included in the touch sensing device 300 of FIG. 4 in the third case CASE3.

Referring to FIGS. 13A to 13C, the touch panel driver 320 may calculate the first to m-th factors F[1] to F[m] for each of the first to m-th touch electrodes TE[1] to TE[m] based on the first to m-th offset values OV[1] to OV[m] corresponding to the first to m-th touch electrodes TE[1] to TE[m], may calculate the first to m-th touch factors TF[1] to TF[m] for each of the first to m-th touch electrodes TE[1] to TE[m] based on the first to m-th factors F[1] to F[m], and may determine whether to update the first to m-th offset values OV[1] to OV[m] based on the first to m-th touch factors TF[1] to TF[m].

The operation of the touch panel driver 320 is substantially the same as the operation of the touch panel driver 320 of FIGS. 11A to 11C except for the first to m-th offset values OV[1] to OV[m]. Thus, the same reference numerals will be used to refer to the same or like parts as those described in the previous embodiment of FIGS. 11A to 11C and any repetitive explanation concerning the above elements will be omitted.

In an embodiment, the touch panel 310 may include the first to 70-th touch electrodes TE[1] to TE[70], the first threshold value A1 may be 100, the second threshold value A2 may be 600, the third threshold value A3 may be 1200, and the fourth threshold value A4 may be 2000.

The touch panel driver 320 may calculate the first to 70-th factors F[1] to F[70] for each of the first to 70-th touch electrodes TE[1] to TE[70].

For example, the 34-th offset value OV[34] of the 34-th touch electrode TE[34] may be 2114. The first adjacent touch electrode ATE[1] of the 34-th touch electrode TE[34] may be the 27-th touch electrode TE[27], the 27-th offset value OV[27] of the 27-th touch electrode TE[27] may be 2121, and the first sub-factor SF[1] may be about 0.3300 by the [Equation 2].

The second adjacent touch electrode ATE[2] of the 34-th touch electrode TE[34] may be the 33-th touch electrode TE[33], the 33-th offset value OV[33] of the 33-th touch electrode TE[33] may be 1420, and the second sub-factor SF[2] may be about 32.8288 by the [Equation 2].

The third adjacent touch electrode ATE[3] of the 34-th touch electrode TE[34] may be the 41-th touch electrode TE[41], the 41-th offset value OV[41] of the 41-th touch electrode TE[41] may be 2173, and the third sub-factor SF[3] may be about 2.7151 by the [Equation 2].

The fourth adjacent touch electrode ATE[4] of the 34-th touch electrode TE[34] is the 35-th touch electrode TE[35], the 35-th offset value OV[35] of the 35-th touch electrode TE[35] may be 2130, and the fourth sub-factor SF[4] may be about 0.7512 by the [Equation 2].

Accordingly, the second sub-factor SF[2] having the maximum value among the first to fourth sub-factors SF[1] to SF[4] of the 34-th touch electrode TE[34] may be determined as the 34-th factor F[34] of the 34-th touch electrode TE[34]. That is, the 34-th factor F[34] of the 34-th touch electrode TE[34] may be about 32.8288.

The touch panel driver 320 may calculate the first to 70-th touch factors TF[1] to TF[70] for each of the first to 70-th touch electrodes TE[1] to TE[70]. For example, the 34-th reference factor RF[34] of the 34-th touch electrode TE[34] may be about 4.6232 and the 34-th factor F[34] of the 34-th touch electrode TE[34] may be about 32.8288. The 34-th touch factor TF[34] of the 34-th touch electrode TE[34] may be about 2821 by the [Equation 3].

The touch panel driver 320 may determine the touch factor TF having the maximum value among the first to 70-th touch factors TF[1] to TF[70] as the maximum touch factor MTF. For example, the 34-th touch factor TF[34] among the first to 70-th touch factors TF[1] to TF[70] for each of the first to 70-th touch electrodes TE[1] to TE[70] may have the maximum value. Accordingly, the 34-th touch factor TF[34] may be the maximum touch factor MTF. The 34-th touch factor TF[34] may be about 2821.

When the maximum touch factor MTF is the 34-th touch factor TF[34] and the 34-th touch factor TF[34] is about 2821, the maximum touch factor MTF is greater than the fourth threshold value A4, so that the touch panel driver 320 may determine the touch type as the third case CASE3. Accordingly, the touch panel driver 320 may not update the first to 70-th offset values OV[1] to OV[70].

The touch panel driver 320 calculates the first to m-th factors F[1] to F[m] for the first to m-th touch electrodes TE[1] to TE[m] based on the first to m-th offset values OV[1] to OV[m], calculates the first to m-th touch factors TF[1] to TF[m] based on the first to m-th factors F[1] to F[m] and the first to m-th reference factors RF[1] to RF[m], determines the maximum touch factor MTF based on the first to m-th touch factors TF[1] to TF[m], and compares the maximum touch factor MTF with the first to fourth threshold values A1 to A4, so that the touch panel driver 320 may accurately distinguish the first to third cases CASE1 to CASE3. The first to third cases CASE1 to CASE3 are accurately distinguished, so that the first to m-th offset values OV[1] to OV[m] may be normally updated. The first to m-th offset values OV[1] to OV[m] are normally updated, so that the touch sensing device 300 may accurately recognize the touch of the user of the display device 1. That is, the reliability of the touch sensing device 300 may be improved and the reliability of the display device 1 including the touch sensing device 300 may be improved.

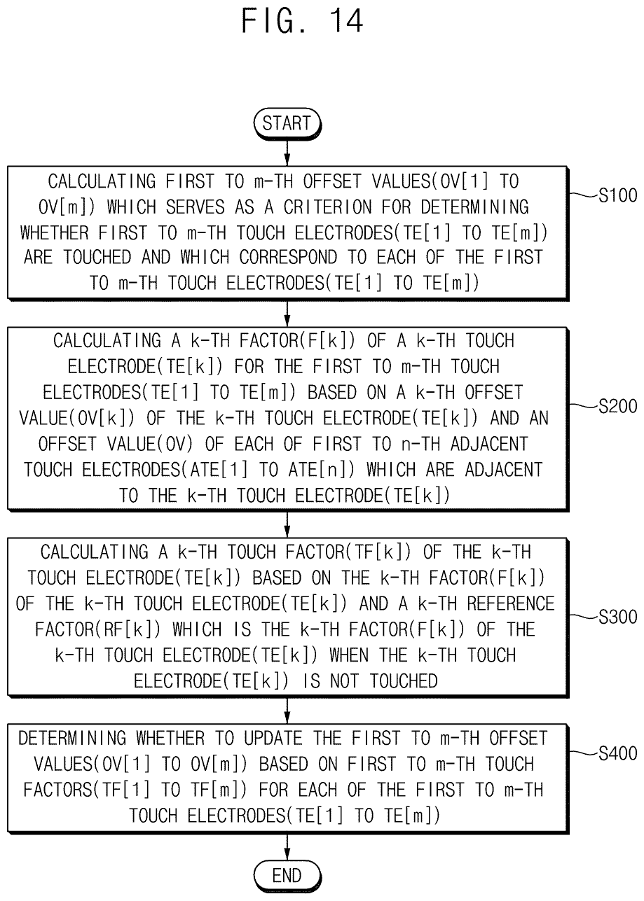

FIG. 14 is a flowchart illustrating a method of operating the display device 1 of FIG. 1.

Referring to FIG. 14, the method of operating the display device 1 may include calculating the first to m-th offset values OV[1] to OV[m] which serves as the criterion for determining whether the first to m-th touch electrodes TE[1] to TE[m] are touched and which correspond to each of the first to m-th touch electrodes TE[1] to TE[m] (S100), calculating the k-th factor F[k] of the k-th touch electrode TE[k] for the first to m-th touch electrodes TE[1] to TE[m] based on the k-th offset value OV[k] of the k-th touch electrode TE[k] and the offset value OV of each of first to n-th adjacent touch electrodes ATE[1] to ATE[n] which are adjacent to the k-th touch electrode TE[k] (S200), calculating the k-th touch factor TF[k] of the k-th touch electrode TE[k] based on the k-th factor F[k] of the k-th touch electrode TE[k] and the k-th reference factor RF[k] which is the k-th factor F[k] of the k-th touch electrode TE[k] when the k-th touch electrode TE[k] is not touched (S300), and determining whether to update the first to m-th offset values OV[1] to OV[m] based on the first to m-th touch factors TF[1] to TF[m] for each of the first to m-th touch electrodes TE[1] to TE[m] (S400).

The calculating the k-th factor F[k] of the k-th touch electrode TE[k] for the first to m-th touch electrodes TE[1] to TE[m] based on the k-th offset value OV[k] of the k-th touch electrode TE[k] and the offset value OV of each of first to n-th adjacent touch electrodes ATE[1] to ATE[n] which are adjacent to the k-th touch electrode TE[k] (S200) may include calculating the first to n-th sub-factors SF[1] to SF[n] of the k-th touch electrode TE[k] based on the k-th offset value OV[k] of the k-th touch electrode TE[k] and the offset value OV of each of the first to n-th adjacent touch electrodes ATE[1] to ATE[n] and determining the sub-factor having the maximum value among the first to n-th sub-factors SF[1] to SF[n] as the k-th factor F[k] of the k-th touch electrode TE[k].

The determining whether to update the first to m-th offset values OV[1] to OV[m] based on the first to m-th touch factors TF[1] to TF[m] for each of the first to m-th touch electrodes TE[1] to TE[m] (S400) may include determining the touch factor TF having the maximum value among the first to m-th touch factors TF[1] to TF[m] as the maximum touch factor MTF.

The determining whether to update the first to m-th offset values OV[1] to OV[m] based on the first to m-th touch factors TF[1] to TF[m] for each of the first to m-th touch electrodes TE[1] to TE[m] (S400) may further include determining whether to update the first to m-th offset values OV[1] to OV[m] for each of the first to m-th touch electrodes TE[1] to TE[m] based on the maximum touch factor MTF and the threshold values.

The method of operating the display device 1 may be performed by the display device 1. In addition, the operation of the display device 1 may be the same as the operation of the display device 1 described in FIGS. 1 to 13C. The method of operating the display device 1 is performed by the touch sensing device 300 included in the display device 1 and the operation of the touch sensing device 300 may be the same as the operation of the touch sensing device 300 described in FIGS. 1 to 13C.

According to the method of operating the display device 1, the touch panel driver 320 calculates the first to m-th factors F[1] to F[m] for the first to m-th touch electrodes TE[1] to TE[m] based on the first to m-th offset values OV[1] to OV[m], calculates the first to m-th touch factors TF[1] to TF[m] based on the first to m-th factors F[1] to F[m] and the first to m-th reference factors RF[1] to RF[m], determines the maximum touch factor MTF based on the first to m-th touch factors TF[1] to TF[m], compares the maximum touch factor MTF with first to fourth threshold values A1 to A4, so that the touch panel driver 320 may accurately distinguish the first to third cases CASE1 to CASE3. The first to third cases CASE1 to CASE3 are accurately distinguished, so that the first to m-th offset values OV[1] to OV[m] may be normally updated. The first to m-th offset values OV[1] to OV[m] are normally updated, so that the touch sensing device 300 may accurately recognize the touch of the user of the display device 1. That is, the reliability of the touch sensing device 300 may be improved and the reliability of the display device 1 including the touch sensing device 300 may be improved.

FIG. 15 is a block diagram illustrating an electronic device 10 according to embodiments of the present inventive concept. FIG. 16 is a diagram illustrating schematics of the electronic device 10 of FIG. 15.

Referring to FIG. 15, the electronic device 10 may include a display module 11, a processor 12, a memory device 13, and a power module 14.

The display device 1 may be applied to various electronic devices. In an embodiment, the electronic device 10 may include the display device 1 of FIG. 1. In an embodiment, the operation of the display device 1 included in the electronic device 10 may be the same as the operation of the display device 1 described with reference FIGS. 1 to 14. In an embodiment, the electronic device 10 may further include modules or devices having other additional functions in addition to the display device 1.

The processor 12 may include at least one of a central processing unit (CPU), an application processor (AP), a graphic processing unit (GPU), a communication processor (CP), an image signal processor (ISP), and controller. The processor 12 may include one or more processors. In implementations with more than one processor, the processors may work individually, collectively or as part of a collective. For example, as part of a collective two out of three processors may operate together to execute instructions for an application.

In an embodiment, the processor 12 may provide the input control signal CONT of FIG. 1 and the input image data IMG of FIG. 1 to the driving controller 210 included in the display device 1 of FIG. 1.

In an embodiment, the processor 12 may be provided as two or more forms in terms of functionality or structure. For example, the processor 12 may include a main processor in the form of a first driving chip including the central processing unit and an auxiliary processor in the form of a second driving chip including the controller that receives an image signal from the main processor and processes the image signal to conform interface specifications of the display module 11. The auxiliary processor may include the driving controller 210 included in the display device 1 of FIG. 1. Accordingly, the main processor may provide the input control signal CONT of FIG. 1 and the input image data IMG of FIG. 1 to the auxiliary processor. The auxiliary processor may process the image signal based on the input control signal CONT and the input image data IMG.

The memory device 13 may include at least one of a non-volatile memory device and a volatile memory device. Data information for an operation of the display module 11 or the processor 12 may be stored in the memory device 13. When the processor 12 executes an application stored in the memory device 13, the input control signal CONT and/or the input image data IMG may be transmitted to the display module 11. The display module 11 may process the input control signal CONT and/or the input image data IMG provided from the processor 12 and may output image information through the display panel.

The power module 13 may include a power supply module, such as a power adapter or a battery device, and a power conversion module that converts power supplied by the power supply module and generates power for the operation of the electronic device 10.

At least one of the components of the electronic device 10 may be included in the display device 1. In addition, some of individual modules functionally included in one module may be included in the display device 1 and others may be provided separately from the display device 1. For example, the display device 1 may include the display module 11, and the processor 12, the memory device 13, and the power module 14 may be provided in the form of other devices in the electronic device 10, other than the display device 1.

Referring to FIG. 16, the various electronic devices having the display device 1 may include an image display electronic device such as a smart phone 10_1a, a tablet PC 10_1b, a laptop computer 10_1c, a TV 10_1d, a desk monitor 10_1e, and the like. In addition, the various electronic devices may include a wearable electronic device including the display module such as smart glasses 10_2a, a head mounted display 10_2b, a smart watch 10_2c, and the like. In addition, the various electronic device may include a vehicle electronic device 10_3 including the display module, such as an instrument panel, a center fascia, a center information display (CID) on a dashboard, a room mirror display, and the like. The electronic device 10 is not limited to the image display electronic device, the wearable electronic device and the vehicle electronic device 10_3.

In an embodiment, the display device 1 included in the electronic device 10 may include the display panel 100 including the pixels PX, the display panel driver 200 which drives the display panel 100, the touch panel 310 including the first to m-th touch electrodes TE[1] to TE[m], and the touch panel driver 320 which drives the touch panel 310.

The touch panel driver 320 may calculate the first to m-th offset values OV[1] to OV[m] which serve as the criterion for determining whether the first to m-th touch electrodes TE[1] to TE[m] are touched and which correspond to each of the first to m-th touch electrodes TE[1] to TE[m], may calculate the k-th factor F[k] of the k-th touch electrode TE[k] for the first to m-th touch electrodes TE[1] to TE[m] based on the k-th offset value OV[k] of the k-th touch electrode TE[k] and the offset value OV of each of the first to n-th adjacent touch electrodes ATE[1] to ATE[n] which are adjacent to the k-th touch electrode TE[k], may calculate the k-th touch factor TF[k] of the k-th touch electrode TE[k] based on the k-th factor F[k] of the k-th touch electrode TE[k] and the k-th reference factor RF[k] which is the k-th factor F[k] of the k-th touch electrode TE[k] when the k-th touch electrode TE[k] is not touched, and may determine whether to update the first to m-th offset values OV[1] to OV[m] based on the first to m-th touch factors TF[1] to TF[m] for each of the first to m-th touch electrodes TE[1] to TE[m].

The touch panel driving circuit 320 calculates first to m-th factors F[1] to F[m] for the first to m-th touch electrodes TE[1] to TE[m] based on first to m-th offset values OV[1] to OV[m], calculates the first to m-th touch factors TF[1] to TF[m] based on the first to m-th factors F[1] to F[m] and the first to m-th reference factors RF[1] to RF[m], determine the maximum touch factor MTF based on the first to m-th touch factors TF[1] to TF[m], and compares the maximum touch factor MTF with first to fourth threshold values A1 to A4, so that the touch panel driver 320 may accurately distinguish first to third cases CASE1 to CASE3. The first to third cases CASE1 to CASE3 are accurately distinguished, so that the first to m-th offset values OV[1] to OV[m] may be normally updated. The first to m-th offset values OV[1] to OV[m] are normally updated, so that the touch sensing device 300 may accurately recognize the touch of the user of the display device 1. That is, the reliability of the touch sensing device 300 may be improved and the reliability of the display device 1 including the touch sensing device 300 may be improved.

The present inventive concepts may be applied to a display device and an electronic device including the display device. For example, the present inventive concepts may be applied to a television (TV), a digital TV, a 3D TV, a mobile phone, a smart phone, a tablet computer, a laptop computer, a personal computer (PC), a household electronic device, a personal digital assistant (PDA), a portable multimedia player (PMP), a digital camera, a music player, a portable game console, a navigation device, etc.

The foregoing is illustrative of the inventive concept and is not to be construed as limiting thereof. Although a few embodiments of the inventive concept have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims. In the claims, means-plus-function clauses are intended to cover the structures described herein as performing the recited function and not only structural equivalents but also equivalent structures. Therefore, it is to be understood that the foregoing is illustrative of the inventive concept and is not to be construed as limited to the specific embodiments disclosed, and that modifications to the disclosed embodiments, as well as other embodiments, are intended to be included within the scope of the appended claims. The inventive concept is defined by the following claims, with equivalents of the claims to be included therein.

What is claimed is:

1. A display device comprising:
a display panel including pixels;
a display panel driver configured to drive the display panel;
a touch panel including first to m-th touch electrodes, where m is an integer equal to or greater than 10; and
a touch panel driver configured to drive the touch panel,
wherein the touch panel driver is configured to:
calculate first to m-th offset values which serve as a criterion for determining whether the first to m-th touch electrodes are touched and which correspond to each of the first to m-th touch electrodes;
calculate a k-th factor, where k is an integer equal to or greater than 1 and less than or equal to m, of a k-th touch electrode for the first to m-th touch electrodes based on a k-th offset value of the k-th touch electrode and an offset value of each of first to n-th adjacent touch electrodes which are adjacent to the k-th touch electrode, where n is an integer equal to or greater than 2 and less than or equal to 4;
calculate a k-th touch factor of the k-th touch electrode based on the k-th factor of the k-th touch electrode and a k-th reference factor which is the k-th factor of the k-th touch electrode when the k-th touch electrode is not touched; and
determine whether to update the first to m-th offset values based on first to m-th touch factors for each of the first to m-th touch electrodes.

2. The display device of claim 1, wherein the touch panel driver is configured to:
calculate first to n-th sub-factors of the k-th touch electrode based on the k-th offset value of the k-th touch electrode and the offset value of each of the first to n-th adjacent touch electrodes; and
determine a sub-factor having a maximum value among the first to n-th sub-factors as the k-th factor of the k-th touch electrode.

3. The display device of claim 1, wherein the touch panel driver is configured to determine a touch factor having a maximum value among the first to m-th touch factors as a maximum touch factor.

4. The display device of claim 3, wherein the touch panel driver is configured to determine whether to update the first to m-th offset values for each of the first to m-th touch electrodes based on the maximum touch factor and threshold values.

5. The display device of claim 4, wherein the touch panel driver is configured to update the first to m-th offset values when the maximum touch factor is less than a first threshold value.

6. The display device of claim 5, wherein the touch panel driver is configured not to update the first to m-th offset values when the maximum touch factor is greater than a second threshold value, the second threshold being greater than the first threshold value, and less than a third threshold value, the third threshold value being greater than the second threshold value.

7. The display device of claim 6, wherein the touch panel driver is configured not to update the first to m-th offset values when the maximum touch factor is greater than a fourth threshold value, the fourth threshold value being greater than the third threshold value.

8. A method of operating a display device comprising:
calculating first to m-th offset values which serves as a criterion for determining whether first to m-th touch electrodes are touched and which correspond to each of the first to m-th touch electrodes, where m is an integer equal to and greater than 10;
calculating a k-th factor of a k-th touch electrode for the first to m-th touch electrodes based on a k-th offset value of the k-th touch electrode, where k is an integer equal to or greater than 1 and less than or equal to m, and an offset value of each of first to n-th adjacent touch electrodes which are adjacent to the k-th touch electrode, where n is an integer equal to or greater than 2 and less than or equal to 4;
calculating a k-th touch factor of the k-th touch electrode based on the k-th factor of the k-th touch electrode and a k-th reference factor which is the k-th factor of the k-th touch electrode when the k-th touch electrode is not touched; and
determining whether to update the first to m-th offset values based on first to m-th touch factors for each of the first to m-th touch electrodes.

9. The method of claim 8, wherein the calculating the k-th factor of the k-th touch electrode for the first to m-th touch electrodes based on the k-th offset value of the k-th touch electrode and the offset value of each of the first to n-th adjacent touch electrodes which are adjacent to the k-th touch electrode includes:
calculating first to n-th sub-factors of the k-th touch electrode based on the k-th offset value of the k-th touch electrode and the offset value of each of the first to n-th adjacent touch electrodes; and
determining a sub-factor having a maximum value among the first to n-th sub-factors as the k-th factor of the k-th touch electrode.

10. The method of claim 8, wherein the determining whether to update the first to m-th offset values based on the first to m-th touch factors for each of the first to m-th touch electrodes includes determining a touch factor having a maximum value among the first to m-th touch factors as a maximum touch factor.

11. The method of claim 10, wherein the determining whether to update the first to m-th offset values based on the first to m-th touch factors for each of the first to m-th touch electrodes further includes determining whether to update the first to m-th offset values for each of the first to m-th touch electrodes based on the maximum touch factor and threshold values.

12. The method of claim 11, wherein in the determining whether to update the first to m-th offset values for each of the first to m-th touch electrodes based on the maximum touch factor and the threshold values, the first to m-th offset values are updated when the maximum touch factor is less than a first threshold value.

13. The method of claim 12, wherein in the determining whether to update the first to m-th offset values for each of the first to m-th touch electrodes based on the maximum touch factor and the threshold values, the first to m-th offset values are not updated when the maximum touch factor is greater than a second threshold value, the second threshold being greater than the first threshold value and less than a third threshold value, the third threshold value being greater than the second threshold value.

14. The method of claim 13, wherein in the determining whether to update the first to m-th offset values for each of the first to m-th touch electrodes based on the maximum touch factor and the threshold values, the first to m-th offset values are not updated when the maximum touch factor is greater than a fourth threshold value, the fourth threshold value being greater than the third threshold value.

15. An electronic device comprising:
one or more processors configured to generate an input control signal and input image data;
a display panel including pixels;
a display panel driver configured to drive the display panel based on the input control signal and the input image data;
a touch panel including first to m-th touch electrodes, where m is an integer equal to and greater than 10; and
a touch panel driver configured to drive the touch panel,
wherein the touch panel driver is configured to:
calculate first to m-th offset values which serve as a criterion for determining whether the first to m-th touch electrodes are touched and which correspond to each of the first to m-th touch electrodes;
calculate a k-th factor of a k-th touch electrode for the first to m-th touch electrodes based on a k-th offset value of the k-th touch electrode, where k is an integer equal to or greater than 1 and less than or equal to m, and an offset value of each of first to n-th adjacent touch electrodes which are adjacent to the k-th touch electrode, where n is an integer equal to or greater than 2 and less than or equal to 4;
calculate a k-th touch factor of the k-th touch electrode based on the k-th factor of the k-th touch electrode and a k-th reference factor which is the k-th factor of the k-th touch electrode when the k-th touch electrode is not touched; and
determine whether to update the first to m-th offset values based on first to m-th touch factors for each of the first to m-th touch electrodes.

16. The electronic device of claim 15, wherein the touch panel driver is configured to:
calculate first to n-th sub-factors of the k-th touch electrode based on the k-th offset value of the k-th touch electrode and the offset value of each of the first to n-th adjacent touch electrodes; and
determine a sub-factor having a maximum value among the first to n-th sub-factors as the k-th factor of the k-th touch electrode.

17. The electronic device of claim 15, wherein the touch panel driver is configured to:
determine a touch factor having a maximum value among the first to m-th touch factors as a maximum touch factor; and
determine whether to update the first to m-th offset values for each of the first to m-th touch electrodes based on the maximum touch factor and threshold values.

18. The electronic device of claim 17, wherein the touch panel driver is configured to update the first to m-th offset values when the maximum touch factor is less than a first threshold value.

19. The electronic device of claim 18, wherein the touch panel driver is configured not to update the first to m-th offset values when the maximum touch factor is greater than a second threshold value, the second threshold value being greater than the first threshold value, and less than a third threshold value, the third threshold value being greater than the second threshold value.

20. The electronic device of claim 19, wherein the touch panel driver is configured not to update the first to m-th offset values when the maximum touch factor is greater than a fourth threshold value, the fourth threshold value being greater than the third threshold value.
